(19) United States
(12) Patent Application Publication
(10) Pub. No.: US 2013/0243488 A1
(43) Pub. Date: Sep. 19, 2013

(54) TONER, TWO-COMPONENT DEVELOPER, AND IMAGE FORMING APPARATUS

(71) Applicants: Satoshi KOJIMA, Shizuoka (JP); Tsuneyasu NAGATOMO, Shizuoka (JP); Syouko SATOH, Miyagi (JP); Osamu UCHINOKURA, Shizuoka (JP); Junichi AWAMURA, Shizuoka (JP); Satoshi OGAWA, Nara (JP); Takahiro HONDA, Shizuoka (JP); Daisuke ITO, Kanagawa (JP); Teruki KUSAHARA, Shizuoka (JP); Masaki WATANABE, Shizuoka (JP); Daisuke INOUE, Shizuoka (JP)

(72) Inventors: Satoshi KOJIMA, Shizuoka (JP); Tsuneyasu NAGATOMO, Shizuoka (JP); Syouko SATOH, Miyagi (JP); Osamu UCHINOKURA, Shizuoka (JP); Junichi AWAMURA, Shizuoka (JP); Satoshi OGAWA, Nara (JP); Takahiro HONDA, Shizuoka (JP); Daisuke ITO, Kanagawa (JP); Teruki KUSAHARA, Shizuoka (JP); Masaki WATANABE, Shizuoka (JP); Daisuke INOUE, Shizuoka (JP)

(21) Appl. No.: 13/790,491

(22) Filed: Mar. 8, 2013

(30) Foreign Application Priority Data
Mar. 14, 2012 (JP) 2012-057366

(51) Int. Cl. G03G 9/08

(52) U.S. Cl. CPC G03G 9/0825
USPC 399/252; 430/108.7

(57) ABSTRACT

A toner including: toner base particles; and external additive, the toner base particles each comprising binder resin and colorant, wherein the external additive comprises coalesced particles, the coalesced particles are each a non-spherical secondary particle in which primary particles are coalesced together, and an index of a particle size distribution of the coalesced particles is expressed by Formula (1):

$$\frac{{Db}_{50}}{{Db}_{10}} ≦ 1.20 \qquad Formula ( 1 )$$

where, in a distribution diagram where particle diameters in nm of the coalesced particles are on horizontal axis and cumulative percentages in % by number of the coalesced particles are on vertical axis and in which the coalesced particles are accumulated from those having smaller particle diameters to those having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

### BACKGROUND OF THE INVENTION

1. Field of the Invention

The present invention relates to a toner used in an electrophotographic image forming apparatus such as a copier, a printer and a facsimile; and a developer and an image forming apparatus using the toner.

2. Description of the Related Art

In the image forming apparatus, an image is fixed onto printing paper after undergoing a charging step, an exposing step, a developing step and a transfer step, wherein the charging step is a step of uniformly charging an image forming region on an image bearing member surface, the exposing step is a step of exposing the image bearing member to write a latent electrostatic image thereon, the developing step is a step of forming an image with the toner that has been charged through friction on the image bearing member, and the transfer step is a step of transferring the image, formed on the image bearing member, onto the printing paper directly or via the intermediate transfer member. Residual toner that has not been transferred and remains on the image bearing member is swept from the image bearing member at the cleaning step, and then a subsequent image forming process starts.

The toner used in the image forming apparatus has been produced by a pulverization method in which a binder resin, a pigment, a charge controlling agent and a releasing agent are melt-kneaded and cooled, followed by pulverizing or classifying. However, in the pulverization method, the toner is difficult to be controlled in particle diameter or shape, and has a broad particle size distribution. Further, a developing roller, a charging roller, a charging blade, a photoconductor and a carrier are likely to be contaminated, which makes it difficult to achieve high image quality and high reliability together. On the other hand, when using a polymerization method, the toner can be easily controlled in particle diameter, which significantly improves the toner in transferability to recording medium (fine dot reproducibility). Accordingly, in recent years, various attempts have been made to produce a toner using the polymerization method such as an emulsification-aggregation-polymerization method or a dissolution-suspension method.

Meanwhile, when fixing the toner in the above image forming apparatus, from the viewpoint of being excellent in energy efficiency, a heating roller method has been widely used, in which a heat roller is directly press-contacted with a toner image on a recording medium. The heating roller method requires a large amount of electric power for fixing. Accordingly, a toner being excellent in low temperature fixability, i.e., a toner which can be fixed on a recording medium even at a low temperature has been demanded from the viewpoint of energy saving.

As the toner being excellent in low temperature fixability, for example, a toner which contains, as a binder resin, a resin having a low-glass transition temperature has been proposed. However, this toner contains a softened resin, so that the toner is less resistant to stress applied from stirring in a developing device and is degraded in heat resistance storageability, which is problematic.

In order to solve a problem regarding to the heat resistance storageability, a toner being excellent in heat resistance storageability has been proposed which toner has a core-shell structure (capsule structure) comprised of core particles containing a resin having a low glass transition temperature, and shell layers (outer coat) containing a resin having a high glass transition temperature and being formed so as to cover surfaces of the core particles (e.g., see Japanese Patent (JP-B) No. 3030741, and Japanese Patent Application Laid-Open (JP-A) Nos. 2000-112174, 2001-201891, and 2001-235894). However, the toner which has a core-shell structure is degraded in transferability to a recording medium because the toner deteriorates rapidly due to low resistance to stress upon developing.

In order to solve a problem regarding to the transferability, a toner has been proposed in which, as an external additive, inorganic particles with varying particle diameters are attached onto surfaces of toner base particles (e.g., see JP-A Nos. 03-100661 and 09-319134, and JP-B Nos. 3328013 and 3056122). However, this toner is disadvantageous in that the inorganic particles are exfoliated from the toner base particles to thereby contaminate regions within a developing device or surrounding a photoconductor, which cause a filming. Because adhesion strength to the toner base particles is different depending on the inorganic particle.

In order to solve a problem regarding to the filming, a toner has been proposed in which, as an external additive, unstructured particles (i.e., an agglomerate of particles) are attached onto surfaces of toner base particles (see, for example, JP-A No. 2010-224502). However, the unstructured particles have a very broad particle size distribution, and contain a large number of small-diameter particles and almost-spherical particles. Therefore, the unstructured particles are very easily embedded into or exfoliated from the toner base particles after long-time use. Accordingly, this toner also has problems in degrading transferability and filming property.

Therefore, there have still not been provided a toner that is satisfactory in all of low temperature fixability, heat resistance storageability, transferability, and filming property even after long-term use in a high-speed full-color image forming. Thus, at present, keen demand has arisen for such toners.

### SUMMARY OF THE INVENTION

The present invention has been made in view of the foregoing, and aims to solve the above existing problems and achieve the following objects. That is, an object of the present invention is to provide a toner that is satisfactory in all of transferability, low temperature fixability, heat resistance storageability and filming property even after long-term use.

The present invention is based on the above finding obtained by the present inventors. Means for solving the problems are as follows.

That is, a toner of the present invention includes: toner base particles; and an external additive, the toner base particles each containing at least a binder resin and a colorant; wherein the external additive contains at least coalesced particles; wherein the coalesced particles are each a non-spherical secondary particle in which primary particles are coalesced together; and wherein a particle size distribution index of the coalesced particles is represented by the following Formula (1).

$$\frac{{Db}_{50}}{{Db}_{10}} ≦ 1.20 \qquad Formula ( 1 )$$

In the Formula (1), in a distribution diagram in which particle diameters (nm) of the coalesced particles are on the horizontal axis and cumulative percentages (% by number) of the coalesced particles are on the vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

The present invention can provide a toner that is satisfactory in all of low temperature fixability, heat resistance storageability, transferability, and filming property even after long-term use. This can solve the above-described existing problems.

### BRIEF DESCRIPTION OF THE DRAWINGS

FIG. 1 is a photograph of one exemplary external additive in the toner of the present invention.

FIG. 2 is a photograph of one exemplary external additive in the toner of the present invention.

FIG. 3 is an explanatory, schematic view of one exemplary image forming apparatus of the present invention.

FIG. 4 is an explanatory, schematic view of another exemplary image forming apparatus of the present invention.

FIG. 5 is an explanatory, schematic view of another exemplary image forming apparatus of the present invention.

FIG. 6 is an explanatory, schematic view of a part of the image forming apparatus shown in FIG. 5.

### DETAILED DESCRIPTION OF THE INVENTION

### (Toner)

A toner of the present invention contains toner base particles and an external additive; and, if necessary, further contains other ingredients.

### <External Additive>

The external additive is not particularly limited and may be appropriately selected depending on the intended purpose, so long as it contains coalesced particles.

### <<Coalesced Particles>>

The coalesced particles are each a non-spherical secondary particle in which primary particles are coalesced together.

Notably, the external additive is not particularly limited so long as it contains at least the coalesced particles (secondary particles); and may further contain a component of the coalesced particles in the state of primary particles.

### -Primary Particles-

The primary particles are not particularly limited and may be appropriately selected depending on the intended purpose. Examples thereof include organic particles and inorganic particles such as silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride. These may be used alone or in combination. Among them, silica is preferred in that it can prevent the external additive from embedded into or exfoliated from the toner base particles.

An average particle diameter (Da) of the primary particles is not particularly limited and may be appropriately selected depending on the intended purpose, but is preferably 20 nm to 150 nm, more preferably 35 nm to 150 nm. When it is smaller than 20 nm, the coalesced particles cannot function as a spacer. Accordingly, when external stress is applied, the coalesced particles cannot suppress the external additive from being embedded into the toner base particles in some cases. When it is larger than 150 nm, the coalesced particles are easily exfoliated from the toner base particles, probably leading to photoconductor filming.

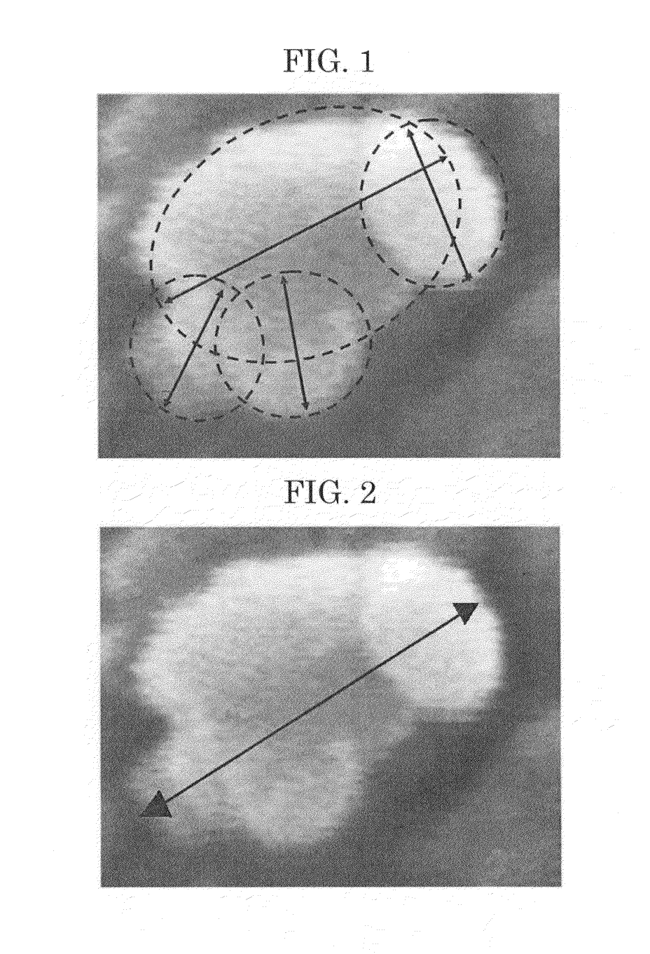

An average particle diameter (Da) of the primary particles is calculated from particle diameters of primary particles in the coalesced particles (lengths of all the arrows shown in FIG. 1). The average particle diameter of the primary particles is measured as follows. Firstly, the secondary particles are dispersed in an appropriate solvent (e.g., tetrahydrofuran (THF)). The resultant dispersion liquid is subjected to solvent removal to dryness on a substrate to thereby obtain a measurement sample. The measurement sample is observed under a field emission type scanning electron microscope (FE-SEM, acceleration voltage: 5 kV to 8 kV, observed magnification: 8,000 to 10,000), and measured for maximum diameters of the primary particles which are aggregated together (lengths of all the arrows shown in FIG. 1) within a field of vision. Based on the measurement results (the number of measured primary particles: 100 or more and 200 or less), the average particle diameter of the primary particles is calculated.

### --Secondary Particles--

The secondary particles refer to the coalesced particles as described above.

The secondary particles is not particularly limited and may be appropriately selected depending on the intended purpose so long as they are particles in which the primary particles chemically bind to each other by a treatment agent described below so that the primary particles are secondarily aggregated together. They are preferably sol-gel silica.

An average particle diameter (Db) of the secondary particles is not particularly limited and may be appropriately selected depending on the intended purpose, but is preferably 80 nm to 200 nm, more preferably 100 nm to 180 nm, particularly preferably 100 nm to 160 nm. When it is smaller than 80 nm, the secondary particles are difficult to function as a spacer. Accordingly, when external stress is applied, the secondary particles cannot suppress the external additive from being embedded into the toner base particles in some cases. When it is larger than 200 nm, the secondary particles are easily exfoliated from the toner base particles, probably leading to photoconductor filming.

The average particle diameter (Db) of the secondary particles is measured as follows. Firstly, the secondary particles are dispersed in an appropriate solvent (e.g., tetrahydrofuran (THF)). The resultant dispersion liquid is subjected to solvent removal to dryness on a substrate to thereby obtain a measurement sample. The measurement sample is observed under a field emission type scanning electron microscope (FE-SEM, acceleration voltage: 5 kV to 8 kV, observed magnification: 8,000 to 10,000), and measured for maximum diameters of the secondary particles (length of an arrow shown in FIG. 2) within a field of vision. Based on the measurement results (the number of measured secondary particles: 100 or more and 200 or less), the average particle diameter of the secondary particles is calculated.

### -Degree of Coalescence of Coalesced Particles-

An average of degrees of coalescence (G) is represented by an average of ratios of the particle diameters of the coalesced particles (secondary particles) to the average particle diameters of primary particles in each of the coalesced particles (each of the ratio being the particle diameter of the secondary particle/the average particle diameter of the primary particles in the secondary particle). The particle diameter of the secondary particle and the average particle diameter of the primary particles are determined using the above-mentioned methods.

The average of degrees of coalescence (G) of the coalesced particles (the particle diameter of the secondary particle/the average particle diameter of the primary particles) is not particularly limited and may be appropriately selected depending on the intended purpose, but is preferably 1.5 to 4.0, more preferably 2.0 to 3.0. When the average of degrees of coalescence (G) is less than 1.5, the external additive easily rolls into concave portions on surfaces of the toner base particles to thereby be embedded into the toner base particles, which may deteriorate transferability. When the average of degrees of coalescence (G) is more than 4.0, the external additive is easily exfoliated from the toner base particles, leading to carrier contamination or photoconductor damage. Accordingly, the formed toner is susceptible to time-dependent deterioration.

A amount of the coalesced particles having a degree of coalescence of less than 1.3 contained in the toner is not particularly limited and may be appropriately selected depending on the intended purpose. It is preferably 10% by number or less relative to a total number of the coalesced particles contained in the toner. The coalesced particles have various degrees of coalescence for a manufacturing reason. The particles having a degree of coalescence of less than 1.3 are particles which are insufficiently coalesced together and which are present in a substantially spherical shape. This shape is unsuitable for suppressing the external additive from being embedded and makes it difficult for the particles to exert a function as a deformed additive. The rate of the coalesced particles having a degree of coalescence of less than 1.3 contained is calculated as follows. At first, 100 or more and 200 or less of coalesced particles are measured for particle diameters of the primary particles and the secondary particles according to the above-mentioned methods. Based on the obtained particle diameters, the degree of coalescence for each of coalesced particles is calculated. The number of the particles having the degree of coalescence of less than 1.3 is divided by the number of the measured particles.

### -Particle Size Distribution Index of Coalesced Particles-

In particular, a toner filming problem can be solved by using the coalesced particles having a particle size distribution index which meets the following Formula (1). A toner having excellent filming property can be obtained by using the coalesced particles having a sharp particle size distribution which meets the following Formula (1).

$$\frac{{Db}_{50}}{{Db}_{10}} ≦ 1.20 \qquad Formula ( 1 )$$

In the Formula (1), in a distribution diagram in which particle diameters (nm) of the coalesced particles are on the horizontal axis and cumulative percentages (% by number) of the coalesced particles are on the vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

The present inventors conducted extensive studies, and have found that using, as an external additive contained in a toner, non-spherical particles having a sharp particle size distribution can prevent the external additive from being embedded into and exfoliated from toner base particles to thereby produce a toner that is satisfactory in all of low temperature fixability, heat resistance storageability, transferability, and filming property even after long-term use in a high-speed full-color image forming.

Due to the above-described properties, the toner of the present invention can maintain high transfer rate and can prevent a filming even after long-term use because the external additive is less likely to be embedded into or exfoliated from toner base particles even when agitating stress is applied to the toner in a developing device.

Generally, in an electrophotographic image forming apparatus, when using a small particle diameter toner, non-electrostatic adhesive force between toner particles and an electrophotographic photoconductor, or toner particles and an intermediate transfer member is increased, which deteriorates transfer efficiency. Particularly, when using a small particle diameter toner in a high-speed machine, non-electrostatic adhesive force between toner particles and an intermediate transfer member is increased due to small particle diameter. In addition, at a transfer nip portion, particularly at a secondary transfer nip portion, a time period within which the toner particles are exposed to a transfer electric field is decreased due to high speed. Therefore, secondary transfer efficiency is significantly decreased, which is well known.

However, in the toner of the present invention, the non-electrostatic adhesive force of toner particles is decreased because the external additive is less likely to be embedded into toner base particles. Therefore, even when a transfer is performed in a short time period, for example even when a transfer is performed using the high-speed machine, satisfactory transfer efficiency can be achieved without inhibiting fixing. Moreover, in the toner of the present invention, even when mechanical stress is applied to the toner from the high-speed machine for a long time, the external additive is less likely to be exfoliated from toner base particles because the external additive is a non-spherical secondary particle in which primary particles are coalesced together. Therefore, the toner of the present invention is excellent in filming property even after long-term.

The Db₅₀ is determined based on the distribution diagram in which the particle diameters of the coalesced particles (nm) are on the horizontal axis and the cumulative percentages (% by number) are on the vertical axis. When the number of the measured coalesced particles is 200, the Db₅₀ is a particle diameter of the 100^{th} largest particle. When the number of the measured coalesced particles is 150, the Db₅₀ is a particle diameter of the 75^{th} largest particle.

The Db₅₀ is measured as follows. Firstly, the coalesced particles are dispersed in an appropriate solvent (e.g., tetrahydrofuran (THF)). The resultant dispersion liquid is subjected to solvent removal to dryness on a substrate to thereby obtain a measurement sample. The measurement sample is observed under a field emission type scanning electron microscope (FE-SEM, acceleration voltage: 5 kV to 8 kV, observed magnification: 8,000 to 10,000), and measured for particle diameters of the coalesced particles within a field of vision to thereby determine a particle diameter of a coalesced particle at which the cumulative percentage is 50% by number. The particle diameters of the coalesced particles are determined by measuring maximum diameters of the aggregated particles (length of an arrow shown in FIG. 2) (the number of measured aggregated particles: 100 or more and 200 or less).

The Db₁₀ is determined based on the distribution diagram in which the particle diameters of the coalesced particles (nm) are on the horizontal axis and the cumulative percentages (% by number) are on the vertical axis. When the number of the measured coalesced particles is 200, the Db₁₀ is a particle diameter of the 20^{th} largest particle. When the number of the measured coalesced particles is 150, the Db₁₀ is a particle diameter of the 15^{th} largest particle.

The Db₁₀ is measured as follows. Firstly, the coalesced particles are dispersed in an appropriate solvent (e.g., tetrahydrofuran (THF)). The resultant dispersion liquid is subjected to solvent removal to dryness on a substrate to thereby obtain a measurement sample. The measurement sample is observed under a field emission type scanning electron microscope (FE-SEM, acceleration voltage: 5 kV to 8 kV, observed magnification: 8,000 to 10,000), and measured for particle diameters of the coalesced particles within a field of vision to thereby determine a particle diameter of a coalesced particle at which the cumulative percentage is 10% by number. The particle diameters of the coalesced particles are determined by measuring maximum diameters of the aggregated particles (length of an arrow shown in FIG. 2) (the number of measured aggregated particles: 100 or more and 200 or less).

The “Db₅₀/Db₁₀” is not particularly limited and may be appropriately selected depending on the intended purpose, so long as it is 1.2 or less. It is preferably 1.15 or less. When the “Db₅₀/Db₁₀” is greater than 1.2, the particle diameters of the coalesced particles are widely distributed and the number of small-diameter particles is increased. This means that there are many “small-diameter particles A” (particles in which primary particles are insufficiently coalesced together and present as it is) and/or “small-diameter particles B” (particles in which primary particles are sufficiently coalesced together but primary particles themselves have small diameters). When there are many “small-diameter particles A,” the coalesced particles cannot exert satisfactory function as a non-spherical external additive. Therefore, the coalesced particles have low embedment-resistant property, possibly leading to abnormal image. When there are many “small-diameter particles B,” the coalesced particles cannot function as a spacer. Accordingly, when external stress is applied, the coalesced particles cannot suppress the external additive from being embedded into the toner base particles in some cases. Therefore, the numbers of the “small-diameter particles A” and the “small-diameter particles B” should be decreased.

A method for decreasing the number of the “small-diameter particles A” and the “small-diameter particles B” is not particularly limited and may be appropriately selected depending on the intended purpose. It is preferably a method in which small-diameter particles are previously removed by classifying.

### -Shape of Coalesced Particles-

A shape of the coalesced particles is not particularly limited and may be appropriately selected depending on the intended purpose, so long as they have a non-spherical shape in which particles are coalesced together. Example thereof includes a non-spherical shape in which two or more particles are coalesced together, as shown in FIGS. 1 and 2. Using such coalesced particles can achieve a toner having high flowability and capable of maintaining high transfer rate for a long period. Because the coalesced particles can suppress the external additive from rolling and being embedded into the toner base particles. Moreover, the coalesced particles can maintain themselves in an aggregated (coalesced) form even under a constant stirring condition, leading to high durability of the toner.

A method for confirming whether the primary particles are coalesced together in the coalesced particles is not particularly limited and may be appropriately selected depending on the intended purpose. Preferred is a method in which particles are observed under a field emission type scanning electron microscope (FE-SEM).

### -Method for Producing Coalesced Particles-

A method for producing the coalesced particles is not particularly limited and may be appropriately selected depending on the intended purpose, but is preferably a sol-gel method. Specifically, preferred is a method in which the secondary particles (coalesced particles) are produced by mixing or firing the primary particles and a treatment agent described below to thereby allow them to be chemically bound and secondarily aggregated together. Notably, in the case of the sol-gel method, the coalesced particles may be prepared in a single step reaction in the presence of the treatment agent.

### --Treatment Agent--

The treatment agent is not particularly limited and may be appropriately selected depending on the intended purpose. Examples thereof include a silane-based treatment agent and an epoxy-based treatment agent. These may be used alone or in combination. In the case where silica is used as the primary particles, the silane-based treatment agent is preferred in that a Si—O—Si bond formed with the silane-based treatment agent is more thermostable than a Si—O—Si bond formed with the epoxy-based treatment agent. If necessary, a treatment aid (e.g., water or 1% by mass acetic acid aqueous solution) may be used.

### ---Silane-Based Treatment Agent---

The silane-based treatment agent is not particularly limited and may be appropriately selected depending on the intended purpose. Examples thereof include alkoxysilanes (e.g., tetramethoxysilane, tetraethoxysilane, methyltrimethoxysilane, methyltriethoxysilane, dimethyldimethoxysilane, dimethyldiethoxysilane, methyldimethoxysilane, methyldiethoxysilane, diphenyl dimethoxysilane, isobutyltrimethoxysilane, decyltrimethoxysilane); silane coupling agents (e.g., γ-aminopropyltriethoxysilane, γ-glycidoxypropyltrimethoxysilane, γ-glycidoxypropylmethyldiethoxysilane, γ-methacryloxypropyl trimethoxysilane, γ-mercaptopropyltrimethoxysilane, vinyltriethoxysilane, methylvinyldimethoxysilane); vinyltrichlorosilane, dimethyldichlorosilane, methylvinyldichlorosilane, methylphenyldichlorosilane, phenyltrichlorosilane, N,N′-bis(trimethylsilyl)urea, N,O-bis(trimethylsilyl)acetoamide, dimethyltrimethylsilylamine, hexamethyldisilazane and a mixture of cyclicsilazane.

The silane-based treatment agent chemically binds to the primary particles (e.g., primary silica particles) to thereby allow them to secondarily aggregate together as follows.

In the case where the primary silica particles are treated with, for example, the alkoxysilans or the silane-based coupling agents serving as the silane-based treatment agent, as shown in the following Formula (A), a silanol group bound to the silica primary particle undergoes a dealcoholization reaction with an alkoxy group bound to the silane-based treatment agent to thereby form a new Si—O—Si bond, resulting in secondarily aggregated particles.

In the case where the primary silica particles are treated with the chlorosilanes serving as the silane-based treatment agent, a chloro group in the chlorosilane undergoes a dehydrochlorination reaction with a silanol group bound to the silane primary particle to thereby form a new Si—O—Si, resulting in secondarily aggregated particles. In the case where the primary silica particles are treated with the chlorosilanes serving as the silane-based treatment agent in the presence of water, the chlorosilanes are firstly hydrolyzed to produce a silanol group, and then the resultant silanol group undergoes a dehydration reaction with a silanol group bound to the silane primary particle to thereby form a new Si—O—Si bond, resulting in secondarily aggregated particles.

In the case where the primary silica particles are treated with silazanes serving as the silane-based treatment agent, an amino group undergoes a deammoniation reaction with a silanol group bound to the silica primary particle to thereby form a new Si—O—Si bond, resulting in secondarily aggregated particles.

—Si—OH+RO—Si—→—Si—O—Si—+ROH Formula (A)

In Formula (A), R represents an alkyl group.

### ---Epoxy-Based Treatment Agent---

The epoxy-based treatment agent is not particularly limited and may be appropriately selected depending on the intended purpose. Examples thereof include bisphenol A type epoxy resins, bisphenol F type epoxy resins, phenolic novolac type epoxy resins, cresol novolac type epoxy resins, bisphenol A novolac type epoxy resins, biphenol type epoxy resins, glycidylamine type epoxy resins and alicyclic epoxy resins.

The epoxy-based treatment agent chemically binds to the primary particles to thereby allow them to secondarily aggregate together as shown in the following Formula (B). In the case where the primary silica particles are treated with the epoxy-based treatment agent, a silanol group bound to the silica primary particle undergoes an addition reaction with an oxygen group in an epoxy group and a carbon atom bound to the epoxy group in the epoxy-based treatment agent to thereby form a new Si—O—Si bond, resulting in secondarily aggregated particles.

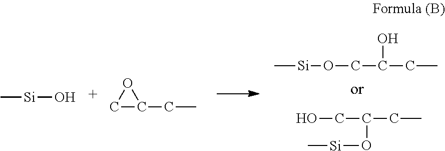

A mixing mass ratio of the treatment agent and the primary particles (primary particles:treatment agent) is not particularly limited and may be appropriately selected depending on the intended purpose, but is preferably 100:0.01 to 100:50. Notably, the more the treatment agent is, the higher the degree of coalescence is.

A method for mixing the treatment agent with the primary particles is not particularly limited and may be appropriately selected depending on the intended purpose. Example thereof includes a method of mixing with known mixers (e.g., spray driers). Notably, the primary particles may be firstly prepared and then the treatment agent may be mixed therewith. Alternatively, the primary particles may be prepared in a single step in the presence of the treatment agent.

A firing temperature of the treatment agent and the primary particles is not particularly limited and may be appropriately selected depending on the intended purpose, but is preferably 100° C. to 2,500° C. The higher the firing temperature is, the higher the degree of coalescence is.

A firing time of the treatment agent and the primary particles is not particularly limited and may be appropriately selected depending on the intended purpose, but is preferably 0.5 hours to 30 hours.

An amount of the external additives contained is not particularly limited and may be appropriately selected depending on the intended purpose, but is preferably 0.5 parts by mass to 4.0 parts by mass relative to 100 parts by mass of the toner base particles.

### <Toner Base Particles>

The toner base particles contain at least a binder resin and a colorant.

### <<Binder Resin>>

The binder resin is not particularly limited and may be appropriately selected depending on the intended purpose. Examples thereof include polyester resins, silicone resins, styrene-acrylic resins, styrene resins, acrylic resins, epoxy resins, diene-based resins, phenol resins, terpene resins, coumarin acid, amide-imide resins, butyral resins, urethane resins and ethylene-vinyl acetate resins. These may be used alone or in combination. Among them, preferred are the polyester resins, and a combination of the polyester resins with any of the above-described resins other than the polyester resins, and more preferred is a resin containing at least crystalline polyester resins and/or non-crystalline polyester resins from the viewpoint of being excellent in low temperature fixability, being capable of smoothing an image surface, and having satisfactory flexibility even when the molecular weight thereof is decreased.

### -Polyester Resin-

The polyester resin is not particularly limited and may be appropriately selected depending on the intended purpose, but is preferably an unmodified polyester resin or a modified polyester resin. Preferably, the unmodified polyester resin and the modified polyester resin are at least partially compatible with each other from the viewpoints of being improved in low temperature fixability and offset resistance. Therefore, the unmodified polyester resin has preferably similar composition to that of the modified polyester resin.

### --Unmodified Polyester Resin--

The unmodified polyester resin is not particularly limited and may be appropriately selected depending on the intended purpose. Examples thereof include an unmodified polyester resin such as a crystalline polyester resin or a non-crystalline polyester resin.

The acid value of the unmodified polyester resin is not particularly limited and may be appropriately selected depending on the intended purpose, but is preferably 1 KOHmg/g to 50 KOHmg/g, more preferably 5 KOHmg/g to 30 KOHmg/g. When it is higher than 50 KOHmg/g, the toner may be degraded in charge stability, particularly depending on a change in the working environment. When it falls within the above preferred range, it is advantageous in that the toner is excellent in charge stability and improved in low temperature fixability due to high affinity with paper upon fixing.

The hydroxyl value of the unmodified polyester resin is not particularly limited and may be appropriately selected depending on the intended purpose, but is preferably 5 KOHmg/g or higher. Notably, the hydroxyl value can be measured using, for example, a method according to JIS K0070-1966. Specifically, 0.5 g of a sample is accurately weighed in a 100 mL measuring flask, and then 5 mL of an acetylating reagent is added thereto. Next, the measuring flask is heated in a hot water bath set to 100° C.±5° C. for 1 hour or 2 hours. Then, the measuring flask is taken out from the hot water bath and left to cool. In addition, water is added to the measuring flask, which is then shaken to thereby decompose acetic anhydride. Next, in order to completely decompose acetic anhydride, the measuring flask is heated again in the hot water bath for 10 min or longer and then left to cool. Thereafter, the wall of the flask is thoroughly washed with an organic solvent. Then, the hydroxyl value is measured at 23° C. using potentiometric automatic titrator DL-53 (product of Mettler-Toledo K.K.) and electrode DG113-SC (product of Mettler-Toledo K.K.), and analyzed using analysis software (LabX Light Version 1.00.000). The titrator is calibrated with a solvent mixture of toluene (120 mL) and ethanol (30 mL). The hydroxyl value is measured under the following measurement conditions shown in Table 1.

TABLE 1

Stir

Speed [%] 25
Time [s] 15
EQP titration
Titrant/Sensor

Titrant CH₃ONa
Concentration [mol/L] 0.1
Sensor DG115
Unit of measurement mV

| Predispensing to volume | |
|---|---|
| Volume [mL] | 1.0 |
| Wait time [s] | 0 |
| Titrant addition Dynamic | |
| dE (set) [mV] | 8.0 |
| dV (min) [mL] | 0.03 |
| dV (max) [mL] | 0.5 |
| Measure mode | Equilibrium controlled |
| dE [mV] | 0.5 |
| dt [s] | 1.0 |
| t (min) [s] | 2.0 |
| t (max) [s] | 20.0 |

Recognition

| | |
|---|---|
| Threshold | 100.0 |
| Steepest jump only | No |
| Range | No |
| Tendency | None |

Termination

| | |
|---|---|
| at maximum volume [mL] | 10.0 |
| at potential | No |
| at slope | No |
| after number EQPs | Yes |
| n = 1 | |
| comb. Termination conditions | No |

Evaluation

| | |
|---|---|
| Procedure | Standard |
| Potential1 | No |
| Potential2 | No |
| Stop for reevaluation | No |

### ---Method for Synthesizing Unmodified Polyester Resin---

A method for synthesizing the unmodified polyester resin is not particularly limited and may be appropriately selected depending on the intended purpose. Example thereof includes a method in which a polyol represented by the following General Formula (1) undergoes a polyesterification reaction with a polycarboxylic acid represented by the following General Formula (2).

A—[OH]ₘ General Formula (1)

B—[COOH]ₙ General Formula (2)

In General Formula (1), A represents C1-C20 alkyl, alkylene, or optionally substituted aromatic or heterocyclic aromatic group, and m denotes an integer of 2 to 4.

In General Formula (2), B represents C1-C20 alkyl, alkylene, or optionally substituted aromatic or heterocyclic aromatic group, and n denotes an integer of 2 to 4.

### ----Polyol----

The polyol represented by General Formula (1) is not particularly limited and may be appropriately selected depending on the intended purpose. Examples thereof include ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, polytetramethylene glycol, sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, 1,3,5-trihydroxymethylbenzene, bisphenol A, bisphenol A ethylene oxide adduct, bisphenol A propylene oxide adduct, hydrogenated bisphenol A, hydrogenated bisphenol A ethylene oxide adduct, and hydrogenated bisphenol A propylene oxide adduct. These may be used alone or in combination.

### ----Polycarboxylic Acid----

The polycarboxylic acid represented by General Formula (2) is not particularly limited and may be appropriately selected depending on the intended purpose. Examples thereof include maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenyl succinic acid, isooctyl succinic acid, isododecenyl succinic acid, n-dodecyl succinic acid, isododecyl succinic acid, n-octenyl succinic acid, n-octyl succinic acid, isooctenyl succinic acid, isooctyl succinic acid, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, enpol trimmer acid, cyclohexanedicarboxylic acid, cyclohexenedicarboxylic acid, butanetetracarboxylic acid, diphenylsulfone tetracarboxylic acid, and ethylene glycol bis(trimellitic acid). These may be used alone or in combination.

### --Modified Polyester Resin--

The modified polyester resin is not particularly limited and may be appropriately selected depending on the intended purpose. Example thereof includes a resin obtained by elongating or cross-linking an “active hydrogen-containing compound” with a “polymer reactive with the active hydrogen-containing compound.”

### ---Active Hydrogen Group-Containing Compound---

The active hydrogen group-containing compound is not particularly limited and may be appropriately selected depending on the intended purpose, so long as it acts, in an aqueous phase, as an elongating agent or a cross-linking agent at the time of elongation reaction or cross-linking reaction of the polymer reactive with the active hydrogen group-containing compound, and it contains an active hydrogen group. When the polymer reactive with the active hydrogen group-containing compound is a below-described isocyanate group-containing polyester prepolymer, amines are preferred from the viewpoint of being capable of increasing the molecular weight.

The active hydrogen group is not particularly limited and may be appropriately selected depending on the intended purpose. Examples thereof include hydroxyl group (e.g., alcoholic hydroxyl group or phenolic hydroxyl group), amino group, carboxyl group and mercapto group. These may be used alone or in combination.

The amines serving as the active hydrogen group-containing compound is not particularly limited and may be appropriately selected depending on the intended purpose. Examples thereof include diamines, trivalent or higher polyamines, amino alcohols, amino mercaptans, amino acids, and compounds obtained by blocking an amino group of these amines. Examples of the diamines include aromatic diamines (e.g., phenylenediamine, diethyltoluenediamine, 4,4′-diaminodiphenylmethane); alicyclic diamines (e.g., 4,4′-diamino-3,3′-dimethyldicyclohexylmethane, diaminecyclohexane and isophoronediamine); and aliphatic diamines (e.g., ethylenediamine, tetramethylenediamine and hexamethylenediamine). Examples of the trivalent or higher polyamines include diethylenetriamine and triethylenetetramine. Examples of the amino alcohols include ethanolamine and hydroxyethylaniline. Examples of the amino mercaptans include aminoethyl mercaptan and aminopropyl mercaptan. Examples of the amino acids include aminopropionic acid and aminocaproic acid. Examples of the compounds obtained by blocking an amino group of these amines include oxazoline compounds and ketimine compounds derived from any of the above amines (e.g., the diamines, the trivalent or higher polyamines, the amino alcohols, the amino mercaptans, and the amino acids) and ketones (e.g., acetone, methy ethyl ketone and methyl isobutyl ketone). These may be used alone or in combination.

Among them, preferred are the diamines, and mixtures containing any of the diamines and a small amount of any of the trivalent or higher polyamines.

---Polymer Reactive with Active Hydrogen-Containing Compound---

The polymer reactive with the active hydrogen-containing compound is not particularly limited and may be appropriately selected depending on the intended purpose, so long as it is a polymer having at least a group which is reactive with the active hydrogen-containing compound. It is preferably an urea bond forming group-containing polyester resin (RMPE), more preferably an isocyanate group-containing polyester prepolymer (hereinafter may be referred to as “polyester prepolymer”) from the viewpoint of being excellent in fluidity and transparency when melted, being easily controlling the molecular weight of high molecular weight components therein, and being excellent in mold releasability.

An average number of isocyanate groups contained in one molecule of the polyester prepolymer is preferably 1 or more, more preferably 1.2 to 5, particularly preferably 1.5 to 4. When the average number is less than 1, the polyester resin modified with urea-bond-forming groups (RMPE) is decreased in the molecular weight, which may deteriorate hot offset resistance.

A mass average molecular weight (Mw) of the polyester prepolymer is not particularly limited and may be appropriately selected depending on the intended purpose, but is preferably 3,000 to 40,000, more preferably 4,000 to 30,000 through gel permeation chromatography (GPC) measurement of soluble matter of the polyester prepolymer in tetrahydrofuran (THF). When the mass average molecular weight (Mw) is less than 3,000, the formed toner may be deteriorated in heat resistance storageability. When the mass average molecular weight (Mw) is greater than 40,000, the formed toner may be deteriorated in low temperature fixability. The mass average molecular weight (Mw) can be measured as follows. Specifically, a column is conditioned in a heat chamber at 40° C., and then tetrahydrofuran (THF) (solvent) is caused to pass through the column at a flow rate of 1 mL/min while the temperature is maintained. Subsequently, a separately prepared solution of a resin sample in tetrahydrofuran (concentration: 0.05% by mass to 0.6% by mass) is injected to the column in an amount of 50 μL to 200 μL. In the measurement of the molecular weight of the sample, the molecular weight distribution is determined based on the relationship between the logarithmic value and the count number in a calibration curve given by using several monodisperse polystyrene-standard samples. The polystyrene-standard samples used for giving the calibration curve may be, for example, those each having the molecular weight of 6×10², 2.1×10², 4×10², 1.75×10⁴, 1.1×10⁵, 3.9×10⁵, 8.6×10⁵, 2×10⁶ and 4.48×10⁶ (available from Pressure Chemical Co. or Tosoh Corporation). Preferably, at least about 10 polystyrene-standard samples are used for giving the calibration curve. A refractive index (RI) detector can be used as a detector.

A method for synthesizing the polyester prepolymer is not particularly limited and may be appropriately selected depending on the intended purpose. For example, the polyester prepolymer can be synthesized by reacting polyisocyanate with a polycondensate of a polyol and a polycarboxylic acid, and an active hydrogen group-containing polyester resin. Specifically, the polyol and the polycarboxylic acid are heated to 150° C. to 280° C. in the presence of a known esterification catalyst (e.g., tetrabutoxytitanate or dibutyltinoxide) with, if necessary, appropriately reducing pressure to remove produced water to thereby obtain a hydroxyl group-containing polyester. Next, the hydroxyl group-containing polyester is allowed to react with the polyisocyanate at 40° C. to 140° C. to thereby obtain the polyester prepolymer.

### ----Polyol----

The polyol is not particularly limited and may be appropriately selected depending on the intended purpose. Examples thereof include diols such as alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexane dimethanol and hydrogenated bisphenol A); bisphenols (e.g., bisphenol A, bisphenol F and bisphenol S); adducts of the above-described alicyclic diols with alkylene oxides (e.g., ethylene oxide, propylene oxide and butylene oxide) and adducts of the above-described bisphenols with alkylene oxides (e.g., ethylene oxide, propylene oxide and butylene oxide); trihydric or higher polyols such as polyhydric aliphatic alcohols (e.g., glycerin, trimethylolethane, trimethylolpropane, pentaerythritol and sorbitol), trihydric or higher phenols (e.g., phenol novolak and cresol novolak) and adducts of trihydric or higher polyphenols with alkylene oxides; and mixtures of the diols and the trihydric or higher polyols. These may be used alone or in combination. Among them, the polyol is preferably the diols, and mixtures of the diols and a small amount of the trihydric or higher polyols. The diols are preferably C2-C12 alkylene glycols, and adducts of bisphenols with alkylene oxides (e.g., bisphenol A ethylene oxide 2 mol adduct, bisphenol A propylene oxide 2 mol adduct and bisphenol A propylene oxide 3 mol adduct).

An amount of the polyol contained in the isocyanate group-containing polyester prepolymer is not particularly limited and may be appropriately selected depending on the intended purpose, but is preferably 0.5% by mass to 40% by mass, more preferably 1% by mass to 30% by mass, particularly preferably 2% by mass to 20% by mass. When the amount is less than 0.5% by mass, the formed toner may be deteriorated in hot offset resistance, potentially making it difficult to achieve both heat resistance storageability and low temperature fixability. When the amount is greater than 40% by mass, the formed toner may be deteriorated in low temperature fixability.

### ----Polycarboxylic Acid----

The polycarboxylic acid is not particularly limited and may be appropriately selected depending on the intended purpose. Examples thereof include alkylene dicarboxylic acids (e.g., succinic acid, adipic acid and sebacic acid); C4-C20 alkenylene dicarboxylic acids (e.g., maleic acid and fumaric acid); C8-C20 aromatic dicarboxylic acids (e.g., terephthalic acid, isophthalic acid and naphthalene dicarboxylic acid); trivalent or higher polycarboxylic acids (C9-C20 aromatic polycarboxylic acids such as trimellitic acid and pyromellitic acid), and mixtures of the dicarboxylic acids and the trivalent or higher polycarboxylic acids. Acid anhydrides or lower alkyl esters of any of the above-described polycarboxylic acids may be used. Examples of the lower alkyl esters include methyl ester, ethyl ester and isopropyl ester. A mixing mass ratio (DIC:TC) of the dicarboxylic acids (DIC) and the trivalent or higher polycarboxylic acids (TC) is not particularly limited and may be appropriately selected depending on the intended purpose. For example, it is preferably 100:0.01 to 100:10, more preferably 100:0.01 to 100:1.

In the polycondensation reaction between the polyol and the polycarboxylic acid, a mixture ratio of the polyol and the polycarboxylic acid is not particularly limited and may be appropriately selected depending on the intended purpose. For example, usually, an equivalent ratio of hydroxyl groups [OH] in the polyol to carboxyl groups [COOH] in the polycarboxylic acid ([OH]/[COOH]) is preferably 2/1 to 1/1, more preferably 1.5/1 to 1/1, particularly preferably 1.3/1 to 1.02/1.

### ----Polyisocyanate----

The polyisocyanate is not particularly limited and may be appropriately selected depending on the intended purpose. Examples thereof include aliphatic polyisocyanates (e.g., tetramethylene diisocyanate, hexamethylene diisocyanate, 2,6-diisocyanatomethylcaproate, octamethylene diisocyanate, decamethylene diisocyanate, dodecamethylene diisocyanate, tetradecamethylene diisocyanate, trimethylhexane diisocyanate and tetramethylhexane diisocyanate); alicyclic polyisocyanates (e.g., isophoron diisocyanate and cyclohexylmethane diisocyanate); aromatic diisocyanates (e.g., tolylene diisocyanate, diphenylmethane diisocyanate, 1,5-naphthylene diisocyanate, diphenylene-4,4′-diisocyanate, 4,4′-diisocyanato-3,3′-dimethyldiphenyl, 3-methyldiphenylmethane-4,4′-diisocyanate and diphenylether-4,4′-diisocyanate); aromatic aliphatic diisocyanates (e.g., α,α,α′,α′-tetramethylxylylene diisocyanate); isocyanurates (e.g., tris-isocyanatoalkyl-isocyanurate and triisocyanatoalkyl-isocyanurate); phenol derivatives thereof, and those blocked with, for example, oxime or caprolactam. These may be used alone or in combination.

An amount of the polyisocyanate contained in the polyester prepolymer is not particularly limited and may be appropriately selected depending on the intended purpose, but is preferably 0.5% by mass to 40% by mass, more preferably 1% by mass to 30% by mass, particularly preferably 2% by mass to 20% by mass. When the amount is less than 0.5% by mass, the formed toner may be deteriorated in hot offset resistance, potentially making it difficult to achieve both heat resistance storageability and low temperature fixability. When the amount is greater than 40% by mass, the formed toner may be deteriorated in low temperature fixability.

An equivalent ratio ([NCO]/[OH]) of isocyanate groups [NCO] in the polyisocyanate to hydroxyl groups [OH] in the active hydrogen group-containing polyester resin (in the case of a hydroxyl group-containing polyester resin) is not particularly limited and may be appropriately selected depending on the intended purpose, but is preferably 5/1 to 1/1, more preferably 4/1 to 1.2/1, particularly preferably 3/1 to 1.5/1. When the equivalent ratio [NCO]/[OH] is less than 1/1, the formed toner may be deteriorated in offset resistance. When the equivalent ratio [NCO]/[OH] is more than 5/1, the formed toner may be deteriorated in low temperature fixability.

If necessary, an organic solvent may be used in a reaction of the polyisocyanate with the hydroxyl group-containing polyester resin. Examples thereof include solvents which is non-reactive with an isocyanate group such as aromatic solvents (e.g., toluene and xylene), ketones (e.g., acetone, methyl ethyl ketone and methyl isobutyl ketone), esters (e.g., ethyl acetate), amides (e.g., dimethylformamide and dimethylacetamide) and ethers (e.g., tetrahydrofuran).

### ---Method for Synthesizing Modified Polyester Resin---

A method for synthesizing the modified polyester resin is not particularly limited and may be appropriately selected depending on the intended purpose. Examples thereof include (1) a method in which a solution or dispersion liquid of toner materials containing the polymer reactive with the active hydrogen group-containing compound is emulsified or dispersed in an aqueous medium (aqueous phase) together with the active hydrogen group-containing compound to thereby form oil droplets, and then the polymer reactive with the active hydrogen group-containing compound undergoes an elongation or cross-linking reaction with the active hydrogen group-containing compound in the aqueous medium; (2) a method in which the solution or dispersion liquid of toner materials is emulsified or dispersed in an aqueous medium to which the active hydrogen group-containing compound has previously been added to thereby form oil droplets, and then the polymer reactive with the active hydrogen group-containing compound undergoes an elongation or cross-linking reaction with the active hydrogen group-containing compound in the aqueous medium; and (3) a method in which the solution or dispersion liquid of toner materials is added and mixed in an aqueous medium, the active hydrogen group-containing compound is added thereto to thereby form oil droplets, and then the polymer reactive with the active hydrogen group-containing compound undergoes an elongation or cross-linking reaction from the interfaces of the particles with the active hydrogen group-containing compound in the aqueous medium. Notably, in the case of (3), the modified polyester resin is preferentially formed at surfaces of the produced toner particles and thus a concentration gradient of the modified polyester resin can be generated within each toner particle. If necessary, a reaction terminator (e.g., diethyl amine, dibutyl amine, butyl amine and lauryl amine; and blocked monoamines such as ketimine compounds) may be used for terminating the elongation or cross-linking reaction. The toner of the present invention contains the elongated or cross-linked polyester resin. Accordingly, regardless of low glass transition temperature, the toner of the present invention has excellent heat resistance storageability compared to conventional polyester based toners.

In the case of the urea-modified polyester resin, a number average molecular weight of the modified polyester resin is not particularly limited and may be appropriately selected depending on the intended purpose. It is preferably 1,000 to 10,000, more preferably 1,500 to 6,000.

A glass transition temperature (Tg) of the modified polyester resin is not particularly limited and may be appropriately selected depending on the intended purpose, but is preferably 30° C. to 70° C., more preferably 40° C. to 65° C. When the glass transition temperature (Tg) is lower than 30° C., the formed toner may be deteriorated in heat resistance storageability. When the glass transition temperature (Tg) is higher than 70° C., the formed toner may have unsatisfactory low temperature fixability. Notably, the glass transition temperature (Tg) is measured using TG-DSC system TAS-100 (product of Rigaku Denki Co., Ltd.) as follows. First, a toner (about 10 mg) is placed in an aluminum container. The aluminum container is placed on a holder unit. The holder unit is then set in an electric oven. The toner is heated from room temperature to 150° C. at a temperature increasing rate of 10° C./min, left to stand at 150° C. for 10 min, cooled to room temperature, and left to stand for 10 min. In a nitrogen atmosphere, the toner is heated again to 150° C. at a temperature increasing rate of 10° C./min to thereby obtain a DSC curve using a differential scanning calorimeter (DSC). Using the obtained DSC curve and the analysis system of TG-DSC system TAS-100, the glass transition temperature (Tg) can be calculated from the tangent point between the base line and the tangential line of the endothermic curve near the glass transition temperature (Tg).

The modified polyester resin is not particularly limited and may be appropriately selected depending on the intended purpose, so long as it is a resin obtained using the above-described synthesizing method. Preferred is a urea-modified polyester resin.

### ---Urea-Modified Polyester Resin---

The urea-modified polyester resin may contain a urethane bond, as well as a urea bond. In this case, a molar ratio (urea bond/urethane bond) of the urea bond to the urethane bond is not particularly limited and may be appropriately selected depending on the intended purpose. It is preferably 100/0 to 10/90, more preferably 80/20 to 20/80, particularly preferably 60/40 to 30/70. When the urea bond in the molar ratio (urea bond/urethane bond) is less than 10, the formed toner may be degraded in hot offset resistance.

The urea-modified polyester resin is not particularly limited and may be appropriately selected depending on the intended purpose. Examples thereof include resins described in the following (1) to (10).

(1) a resin containing a mixture of: a polycondensation product of bisphenol A ethyleneoxide 2 mol adduct and isophthalic acid; and a urea-modified product with isophorone diamine of a polyester prepolymer which the polyester prepolymer is obtained by reacting a polycondensation product of bisphenol A ethyleneoxide 2 mol adduct and isophthalic acid with isophorone diisocyanate.

(2) a resin containing a mixture of: a polycondensation product of bisphenol A ethyleneoxide 2 mol adduct and terephthalic acid; and a urea-modified product with isophorone diamine of a polyester prepolymer which the polyester prepolymer is obtained by reacting a polycondensation product of bisphenol A ethyleneoxide 2 mol adduct and isophthalic acid with isophorone diisocyanate.

(3) a resin containing a mixture of: a polycondensation product of terephthalic acid and bisphenol A ethyleneoxide 2 mol adduct/bisphenol A propyleneoxide 2 mol adduct; and a urea-modified product with isophorone diamine of a polyester prepolymer which the polyester prepolymer is obtained by reacting a polycondensation product of terephthalic acid and bisphenol A ethyleneoxide 2 mol adduct/bisphenol A propyleneoxide 2 mol adduct with isophorone diisocyanate.

(4) a resin containing a mixture of: a polycondensation product of bisphenol A propyleneoxide 2 mol adduct and terephthalic acid; and a urea-modified product with isophorone diamine of a polyester prepolymer which the polyester prepolymer is obtained by reacting a polycondensation product of terephthalic acid and bisphenol A ethyleneoxide 2 mol adduct/bisphenol A propyleneoxide 2 mol adduct with isophorone diisocyanate.

(5) a resin containing a mixture of: a polycondensation product of bisphenol A ethyleneoxide 2 mol adduct and terephthalic acid; and a urea-modified product with hexamethylene diamine of a polyester prepolymer which the polyester prepolymer is obtained by reacting a polycondensation product of bisphenol A ethyleneoxide 2 mol adduct and terephthalic acid with isophorone diisocyanate.

(6) a resin containing a mixture of: a polycondensation product of terephthalic acid and bisphenol A ethyleneoxide 2 mol adduct/bisphenol A propyleneoxide 2 mol adduct; and a urea-modified product with hexamethylene diamine of a polyester prepolymer which the polyester prepolymer is obtained by reacting a polycondensation product of bisphenol A ethyleneoxide 2 mol adduct and terephthalic acid with isophorone diisocyanate.

(7) a resin containing a mixture of: a polycondensation product of bisphenol A ethyleneoxide 2 mol adduct and terephthalic acid; and a urea-modified product with ethylene diamine of a polyester prepolymer which the polyester prepolymer is obtained by reacting a polycondensation product of bisphenol A ethyleneoxide 2 mol adduct and terephthalic acid with isophorone diisocyanate.

(8) a resin containing a mixture of: a polycondensation product of bisphenol A ethyleneoxide 2 mol adduct and isophthalic acid; and a urea-modified product with hexamethylene diamine of a polyester prepolymer which the polyester prepolymer is obtained by reacting a polycondensation product of bisphenol A ethyleneoxide 2 mol adduct and isophthalic acid with diphenylmethane diisocyanate.

(9) a resin containing a mixture of: a polycondensation product of terephthalic acid and bisphenol A ethyleneoxide 2 mol adduct/bisphenol A propyleneoxide 2 mol adduct; and a urea-modified product with hexamethylene diamine of a polyester prepolymer which the polyester prepolymer is obtained by reacting a polycondensation product of bisphenol A ethyleneoxide 2 mol adduct/bisphenol A propyleneoxide 2 mol adduct and terephthalic acid/dodecenylsuccinic anhydride with diphenylmethane diisocyanate.

(10) a resin containing a mixture of: a polycondensation product of bisphenol A ethyleneoxide 2 mol adduct and isophthalic acid; and a urea-modified product with hexamethylene diamine of a polyester prepolymer which the polyester prepolymer is obtained by reacting a polycondensation product of bisphenol A ethyleneoxide 2 mol adduct and isophthalic acid with toluene diisocyanate.

A method for synthesizing the urea-modified polyester resin is not particularly limited and may be appropriately selected depending on the intended purpose. Example thereof includes a one-shot method. Specifically, an isocyanate group-containing polyester prepolymer serving as the polymer reactive with the active hydrogen group-containing compound undergoes an elongation or cross-linking reaction with amines serving as the active hydrogen group-containing compound in the aqueous medium. The elongation or cross-linking reaction conditions are not particularly limited and may be appropriately selected depending on a combination of the active hydrogen group-containing compound and the polymer reactive with the active hydrogen group-containing compound. A reaction time is preferably 10 min to 40 hours, more preferably 2 hours to 24 hours.

In the synthesis of the urea-modified polyester resin, a mixture ratio of the amines and the isocyanate group-containing polyester prepolymer is not particularly limited and may be appropriately selected depending on the intended purpose. The mixture ratio is preferably 1/3 to 3/1, more preferably 1/2 to 2/1, particularly preferably 1/1.5 to 1.5/1, in terms of an equivalent ratio ([NCO]/[NHx]) of isocyanate groups [NCO] in the polyester prepolymer to amino groups [NHx] in the amines. When the equivalent ratio ([NCO]/[NHx]) is less than 1/3, the formed toner may be deteriorated in low temperature fixing property. When the equivalent ratio ([NCO]/[NHx]) is greater than 3/1, the molecular weight of the urea-modified polyester resin may be decreased, which may deteriorate hot offset resistance.

In the case where the amines are allowed to react with the isocyanate group-containing polyester prepolymer in the synthesis of the urea-modified polyester resin, if necessary, an organic solvent may be used. Examples thereof include solvents which are non-reactive with an isocyanate group such as aromatic solvents (e.g., toluene and xylene), ketones (e.g., acetone, methyl ethyl ketone and methyl isobutyl ketone), esters (e.g., ethyl acetate), amides (e g., dimethylformamide and dimethylacetamide) and ethers (e.g., tetrahydrofuran).

### <<Colorant>>

The colorant is not particularly limited and may be appropriately selected from any known dyes or pigments depending on the intended purpose. Examples of the colorant include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment red, pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower and lithopone. These may be used alone or in combination.

An amount of the colorant contained in the toner is not particularly limited and may be appropriately selected depending on the intended purpose, but is preferably 1% by mass to 15% by mass, more preferably 3% by mass to 10% by mass. When the amount is less than 1% by mass, the toner may be deteriorated in coloring power. When the amount is greater than 15% by mass, a pigment cannot be sufficiently dispersed in the toner, and the toner may be deteriorated in coloring power and electric property.

The colorant may be mixed with a resin to form a masterbatch. The resin is not particularly limited and may be appropriately selected depending on the intended purpose. Examples of the resin include polyester resins; polymers of styrene or substituted products thereof (e.g., poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers); polymethyl methacrylates; polybutyl methacrylates; polyvinyl chloride resins; polyvinyl acetate resins; polyethylene resins; polypropylene resins; epoxy resins; epoxy polyol resins; polyurethane resins; polyamide resins; polyvinyl butyral resins; polyacrylic acid resins; rosin; modified rosin; terpene resins; aliphatic hydrocarbon resins; alicyclic hydrocarbon resins; aromatic petroleum resins; chlorinated paraffins; and paraffin waxes. These may be used alone or in combination.

A method for producing the masterbatch is not particularly limited and may be appropriately selected depending on the intended purpose. For example, the masterbatch can be produced by mixing or kneading the colorant and an organic solvent with a resin for use in a masterbatch through application of high shearing force. Notably, the organic solvent is added in order to enhance interactions between the colorant and the binder resin. Also, the other method for producing the masterbatch is not particularly limited and may be appropriately selected depending on the intended purpose, but a flashing method, in which an aqueous paste containing a colorant is mixed or kneaded with the binder resin and an organic solvent and then the colorant is transferred to the resin followed by removing water and the organic solvent, is preferable in that a wet cake of the colorant can be directly used (i.e., no drying is required). Notably, in this mixing or kneading, a high-shearing disperser (e.g., three-roll mill) is preferably used.

### <Other Ingredients>

The other ingredients are not particularly limited and may be appropriately selected depending on the intended purpose. Examples thereof include a releasing agent, a layered inorganic mineral, a magnetic material, a cleanability improving agent, a flowability improving agent, and a charge controlling agent.

### -Releasing Agent-

The releasing agent is not particularly limited and may be appropriately selected depending on the intended purpose. Examples thereof include waxes such as vegetable waxes (e.g., carnauba wax, cotton wax, Japan wax and rice wax), animal waxes (e.g., bees wax and lanolin), mineral waxes (e.g., ozokelite and ceresine) and petroleum waxes (e.g., paraffin waxes, microcrystalline waxes and petrolatum); those other than natural waxes such as synthetic hydrocarbon waxes (e.g., Fischer-Tropsch waxes and polyethylene waxes) and synthetic waxes (e.g., ester waxes, ketone waxes and ether waxes); fatty acid amides such as 1,2-hydroxystearic acid amide, stearic amide, phthalic anhydride imide and chlorinated hydrocarbons; crystalline polymers having a long chain alkyl group as a side chain (e.g., homopolymers or copolymers of low-molecular weight crystalline polymers such as poly-n-stearyl methacrylate and poly-n-lauryl methacrylate n-stearyl acrylate-ethyl methacrylate copolymers)). Among them, preferred is a wax having a melting point of 50° C. to 120° C. from the viewpoint of effectively exhibiting its releasing effects on an interface between a fixing roller and each toner particle. Thus, even when a releasing agent such as oil is not applied onto the fixing roller, excellent hot offset resistance can be attained.

The melting point of the releasing agent is not particularly limited and may be appropriately selected depending on the intended purpose, but is preferably 50° C. to 120° C., more preferably 60° C. to 90° C. When the melting point is lower than 50° C., waxes may adversely affect storageability of the formed toner. When the melting point is higher than 120° C., cold offset may easily occur upon fixing at a low temperature. Notably, the melting point of the releasing agent is determined by measuring the maximum endothermic peak using a differential scanning calorimeter TG-DSC system (TAS-100, product of Rigaku Corporation).

The melt viscosity of the releasing agent is not particularly limited and may be appropriately selected depending on the intended purpose. It is, as measured at the temperature 20° C. higher than the melting point of the wax, preferably 5 cps to 1,000 cps, more preferably 10 cps to 100 cps. When the melt viscosity is lower than 5 cps, the formed toner may be degraded in releasing ability. When the melt viscosity is higher than 1,000 cps, hot offset resistance and low temperature fixability cannot be improved in some cases.

The amount of the releasing agent contained in the toner is not particularly limited and may be appropriately selected depending on the intended purpose. The amount of the releasing agent is preferably 40% by mass or less, more preferably 3% by mass to 30% by mass. When the amount is higher than 40% by mass, the formed toner may be degraded in flowability.

The releasing agent is preferably present in a dispersed state in the toner base particle. Therefore, the releasing agent is preferably incompatible with the binder resin. A method for finely dispersing the releasing agent in the toner base particle is not particularly limited and may be appropriately selected depending on the intended purpose. Example thereof includes a method in which the releasing agent is dispersed with applying the shear force upon kneading in the production of the toner.

Whether the releasing agent is in a dispersed state can be determined by observing a thin film section of the toner particle under a transmission electron microscope (TEM). The dispersion diameter of the releasing agent is preferably smaller. However, when the dispersion diameter is excessively small, oozing during the fixation may be unsatisfactory. Accordingly, when the releasing agent can be observed at a magnification of 10,000 times, it can be considered that the releasing agent is present in a dispersed state. When the releasing agent is so small that the releasing agent cannot be observed at a magnification of 10,000 times, oozing of the releasing agent during the fixation may be unsatisfactory even when the releasing agent is finely dispersed in the toner base particle.

### -Layered Inorganic Mineral-

The modified layered inorganic mineral is not particularly limited and may be appropriately selected depending on the intended purpose, so long as it is an inorganic mineral in which layers with a thickness of several nanometers are laminated on top of each other. Examples thereof include montmorillonite, bentonite, hectorite, attapulgite, sepiolite and mixtures thereof. These may be used alone or in combination. Among them, preferred is a modified layered inorganic mineral, and more preferred is a modified layered inorganic mineral in which a montmorillonite-based crystalline structure is modified with organic cations in that it can be deformed during the granulation of toner, and exhibits a charge controlling function and excellent low temperature fixability. Also, particularly preferable is an organically modified montmorillonite or bentonite in that toner properties are not adversely affected, and viscosity can be easily adjusted.

The modified layered inorganic compound is preferably a layered inorganic mineral of which at least some ions have been modified with organic ions. By modifying at least some of ions of the layered inorganic mineral with organic ions, appropriate hydrophobicity can be yielded, an oil phase containing a toner composition and/or toner composition precursor has a non-Newtonian viscosity, and the toner can be deformed.

An amount of the modified layered inorganic mineral contained in the toner base particles is not particularly limited and may be appropriately selected depending on the intended purpose. It is preferably 0.05% by mass to 5% by mass.

### -Magnetic Material-

The magnetic material is not particularly limited and may be appropriately selected depending on the intended purpose. Examples thereof include iron powder, magnetite and ferrite. Among them, preferred is those being white from the viewpoint of color tone.

### --Cleanability Improving Agent--

The cleanability improving agent is not particularly limited and may be appropriately selected depending on the intended purpose, so long as it is added to the toner in order to facilitate removal of the developer remaining on a photoconductor and a primary transfer medium after transfer. Examples thereof include fatty acid metal salts such as zinc stearate, calcium stearate, and stearic acid; and polymer particles produced through soap-free emulsification polymerization such as polymethyl methacrylate particles and polystyrene particles. A volume average particle diameter of the polymer particle is not particularly limited and may be appropriately selected depending on the intended purpose, but preferably has a relatively narrow particle size distribution, more preferably is 0.01 μm to 1 μm.

### -Flowability Improving Agent-

The flowability improving agent is an agent which can improve hydrophobic properties through surface treatment and can prevent flowability or chargeability from being degraded under high humidity environment. Examples thereof include silane coupling agents, silylation agents, silane coupling agents having a fluorinated alkyl group, organotitanate coupling agents, aluminum-based coupling agents, silicone oils, and modified silicone oils. Notably, the flowability improving agent may be surface-treated with, for example, silica or titanium oxide. In this case, it is preferably used as hydrophobized silica or hydrophobized titanium oxide.

### -Charge Controlling Agent-

The charge controlling agent is not particularly limited and may be appropriately selected depending on the intended purpose. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine-based active agents, metal salts of salicylic acid, metal salts of salicylic acid derivatives, copper phthalocyanine, perylene, quinacridone, azo pigments, and polymeric compounds having a functional group (e.g., a sulfonic acid group, carboxyl group or quaternary ammonium salt).

Examples of commercially available charge controlling agents include BONTRON 03 (nigrosine dye), BONTRON P-51 (quaternary ammonium salt), BONTRON S-34 (metal-containing azo dye), E-82 (oxynaphthoic acid-based metal complex), E-84 (salicylic acid-based metal complex) and E-89 (phenol condensate) (all products of ORIENT CHEMICAL INDUSTRIES CO., LTD); TP-302 and TP-415 (quaternary ammonium salt molybdenum complex (all products of Hodogaya Chemical Co.); COPY CHARGE PSY VP 2038 (quaternary ammonium salt), COPY BLUE PR (triphenylmethane derivative), COPY CHARGE NEG VP2036 (quaternary ammonium salt) and COPY CHARGE NX VP434 (all products of Clariant (Japan) K.K.); LRA-901 and LR-147 (all products of Japan Carlit Co., Ltd.).

The amount of the charge controlling agent is not particularly limited and may be appropriately selected depending on the intended purpose. It is preferably 0.1 parts by mass to 10 parts by mass, more preferably 0.2 parts by mass to 5 parts by mass, per 100 parts by mass of the binder resin. When the amount of the charge controlling agent is more than 10 parts by mass, the formed toner has too high chargeability, resulting in that the charge controlling agent exhibits reduced effects. As a result, the electrostatic force increases between the developing roller and the developer, possibly leading to lowered fluidity of the developer and lowered image density. The charge controlling agent may be melt-kneaded together with toner materials such as a masterbatch or resin before dissolution or dispersion. Alternatively, it may be directly added at the time when toner materials are dissolved or dispersed in an organic solvent. Alternatively, after the formation of toner particles on the toner surface, it may be fixed on the toner particles.

### <Method for Producing Toner>

A method for producing a toner is not particularly limited and may be appropriately selected depending on the intended purpose. Examples thereof include a pulverization method and a polymerization method. Among them, the polymerization method is preferred and an aqueous granulation method is more preferred from the viewpoint of attaining small-particle diameter toner.

### <<Pulverization Method>>

The pulverization method is not particularly limited and may be appropriately selected depending on the intended purpose. Examples thereof include a method in which toner materials are melted or kneaded, followed by pulverizing or classifying to thereby produce toner base particles. Notably, for the purpose of achieving a toner having an average circularity of 0.97 to 1.0, a mechanical impact may be applied to the resultant toner base particles to thereby control their shape. In this case, the mechanical impact may be applied using a device such as a hybridizer or a mechano-fusion. Also, the toner of the present invention is obtained by treating the thus produced toner base particles with an external additive.

### <<Polymerization Method>>

The polymerization method is not particularly limited and may be appropriately selected depending on the intended purpose. Examples thereof include a suspension-polymerization method, a dissolution-suspension-polymerization method, and an emulsification-polymerization-aggregation method. Among them, preferred is the emulsification-polymerization-aggregation method, and more preferred is the dissolution suspension polymerization method.

### -Emulsification-Polymerization-Aggregation Method-

The emulsification-polymerization-aggregation method is not particularly limited and may be appropriately selected depending on the intended purpose. It preferably includes an aggregation step, a fusing step, a washing or drying step, and an external additive treatment step. Specific example thereof include a method in which an oil phase containing a toner composition or a toner composition precursor is dispersed or emulsified in an aqueous phase (aqueous medium), followed by granulating to thereby produce toner base particles. Also, the toner of the present invention is obtained by treating the thus produced toner base particles with an external additive.

### --Aggregation Step--

The aggregation step is a step of preparing an aggregated particle dispersion liquid by mixing a resin particle dispersion liquid prepared through an emulsification polymerization; a layered inorganic mineral of which at least some ions have been modified with organic ions; a colorant dispersion liquid; and, if necessary, a releasing agent dispersion liquid. The aggregated particles in the aggregated particle dispersion liquid are aggregated by heteroaggregation. An ionic surfactant having the opposite polarity to that of the aggregated particles, and/or a monovalent or higher compound such as a metal salt may be added for the purpose of stabilizing the aggregated particles, and controlling particle diameters and/or particle size distribution of the aggregated particles.

In the aggregation step, emulsifying power of an emulsifying agent is adjusted with pH to thereby allow aggregation to occur so that the resulting aggregated particles can be controlled. At the same time as the above, an aggregating agent may be added in order to stably and promptly form aggregated particles with a narrow particle size distribution. The aggregating agent is not particularly limited and may be appropriately selected depending on the intended purpose. It is preferably a monovalent or higher compound. Specific examples thereof include a water-soluble surfactants such as a nonionic surfactant; acids such as chloric acid, sulfuric acid, nitric acid, acetic acid, and oxalic acid; metal salts of inorganic acids such as magnesium chloride, sodium chloride, aluminum sulfate, calcium sulfate, ammonium sulfate, aluminum nitrate, silver nitrate, copper sulfate, and sodium carbonate; metal salts of aliphatic acids or aromatic acids such as sodium acetate, potassium formate, sodium oxalate, sodium phthalate and potassium salicylate; metal salts of phenols such as sodium phenolate; metal salts of amino acids; and inorganic acid salts of aliphatic or aromatic amines such as triethanol amine hydrochloride and aniline hydrochloride. Among them, metal salts of inorganic acids are preferable in the light of stability of the aggregated particles, stability of the aggregating agent to heat or time-lapse, and the removability of the aggregating agent during washing. An amount of the aggregating agent is not particularly limited and varies depending on the valency thereof. In the case of a monovalent aggregating agent, it is 3% by mass or less. In the case of a bivalent aggregating agent, it is 1% by mass or less. In the case of a trivalent aggregating agent, it is 0.5% by mass or less. The smaller amount of the aggregating agent is more preferable. A compound with higher valency is preferable from the viewpoint of decreasing the amount added.

### --Fusing Step--

The fusing step is a step of forming the toner base particles by heating and fusing the aggregated particles dispersion liquid. Prior to the fusing step, a deposition step may be performed. The deposition step is a step of adding and mixing a dispersion liquid of other particles to the aggregated particle dispersion liquid, followed by uniformly depositing the other particles on surfaces of the aggregated particles to thereby form deposited particles. In order to tightly attach the aggregated particles to the layered inorganic mineral of which at least some ions have been modified with organic ions, a deposition step may be performed. Specifically, the layered inorganic mineral of which at least some ions have been modified with organic ions is attached to the aggregated particles, a dispersion liquid of other particles is added to and mixing with the aggregated particle dispersion liquid, followed by uniformly depositing the other particles on surfaces of the aggregated particles to thereby form deposited particles. These deposited particles are formed by, for example, heteroaggregation. A dispersion liquid of the deposited particles is also heated to the temperature equal to or higher than the glass transition temperature of the resin particles as described above to thereby fuse the deposited particles together, resulting in forming fused particles. The fused particles are present as a colored fused-particle dispersion liquid in an aqueous medium. The fused particles are separated from the aqueous medium in a washing step, at the same time as removing or drying the impurities contaminated in each steps to thereby obtain a toner as a powder.

### --Washing Step--

In the washing step, acidic or basic water is added to the fused particles in an amount several times as that of the fused particles, followed by stirring and filtration. To the resultant solid component, acidic or basic water is added in an amount several times as that of the solid component, followed by stirring and filtration. This operation is repeated several times until pH of the filtrate becomes approximately 7, to thereby obtain colored toner particles.

### --Drying Step--

In the drying step, the toner particles obtained in the washing step is dried at the temperature lower than the glass transition temperature of the toner particles. During the drying, dry air may be circulated, or heating may be performed in the vacuumed condition, if necessary.

### --Dissolution-Suspension Method--

The dissolution-suspension method is not particularly limited and may be appropriately selected depending on the intended purpose. It is preferably a method in which the toner is produced through aqueous granulation, more preferably a method which includes an oil phase preparing step, an aqueous phase preparing step, an emulsification or dispersion step, a solvent removing step, a washing or drying step, and an external additive treatment step.

A specific example of the dissolution-suspension method is not particularly limited and may be appropriately selected depending on the intended purpose, but is preferably a method in which at least the binder resin and the colorant are dissolved or dispersed in an organic solvent, the resultant solution or dispersion liquid is added to an aqueous phase, followed by emulsifying or dispersing, the organic solvent is removed from the resultant emulsion or dispersion liquid to thereby obtain toner base particles, and then the resultant toner base particles are mixed with an external additive to thereby produce a toner.

Among the dissolution-suspension methods, preferred is an ester elongation method. A specific preferred example of the ester elongation method is a method in which at least the active hydrogen group-containing compound, the polymer reactive with the active hydrogen group-containing compound, the binder resin and the colorant are dissolved or dispersed in an organic solvent, the resultant solution or dispersion liquid is added to an aqueous phase, followed by emulsifying or dispersing, the polymer reactive with the active hydrogen group-containing compound undergoes an elongation or cross-linking reaction with the active hydrogen group-containing compound in the resultant emulsion or dispersion liquid, the organic solvent is removed from the emulsion or dispersion liquid to thereby obtain toner base particles, and then the resultant toner base particles are mixed with an external additive to thereby produce a toner.

### --Oil Phase Preparing Step--

The oil phase preparing step is a step of preparing an oil phase (a solution or dispersion liquid of toner materials) by dissolving or dispersing the toner materials containing at least the binder resin and the colorant in an organic solvent. Ingredients other than the polymer reactive with the active hydrogen group-containing compound contained in the toner materials may be added to and mixed with an aqueous medium in a below described aqueous phase preparing step, or may be added to an aqueous phase together with the solution or dispersion liquid of the toner materials at the time when the solution or dispersion liquid is added to the aqueous medium. The organic solvent is not particularly limited and may be appropriately selected depending on the intended purpose, but preferably is an organic solvent having a boiling point of lower than 150° C. from the viewpoint of easily removing the solvent. The organic solvent having a boiling point of lower than 150° C. is not particularly limited and may be appropriately selected depending on the intended purpose. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination. Among them, preferred are ethyl acetate, toluene, xylene, benzene, methylene chloride, 1,2-dichloroethane, chloroform, carbon tetrachloride, and more preferred is ethyl acetate. The amount of the organic solvent used is not particularly limited and may be appropriately selected depending on the intended purpose. It is preferably 40 parts by mass to 300 parts by mass, more preferably 60 parts by mass to 140 parts by mass, particularly preferably 80 parts by mass to 120 parts by mass, per 100 parts of the toner materials.

### --Aqueous Phase Preparing Step--

The aqueous phase preparing step is a step of preparing an aqueous phase (aqueous medium). The aqueous phase is not particularly limited and may be appropriately selected depending on the intended purpose. Examples thereof include water, a water-miscible solvent, and a mixture thereof. These may be used alone or in combination. Among them, preferred is water. Examples of the water-miscible solvent include alcohols (e.g., methanol, isopropanol and ethylene glycol), dimethylformamide, tetrahydrofuran, cellosolves (e.g., methyl cellosolve (registered trademark)) and lower ketones (e.g., acetone and methyl ethyl ketone).

### --Emulsification or Dispersion Step--

The emulsification or dispersion step is a step of dispersing the oil phase in the aqueous phase to thereby obtain an emulsion or dispersion. The toner materials may not necessarily added to the aqueous phase before particle formation. The toner materials may be added to the aqueous phase after particle formation. For example, after particles containing no colorant are formed, a colorant may be added to the obtained particles using a known dying method. An amount of the aqueous phase used is not particularly limited and may be appropriately selected depending on the intended purpose. It is preferably 50 parts by mass to 2,000 parts by mass, more preferably 100 parts by mass to 1,000 parts by mass, per 100 parts by mass of the toner materials. When the amount of the aqueous medium used is less than 50 parts by mass, the toner materials are poorly dispersed, resulting in that toner particles having a predetermined particle diameter cannot obtained in some cases. When the amount of the aqueous medium used is more than 2,000 parts by mass, the production cost may be elevated. If necessary, a dispersing agent may be used. Use of the dispersing agent is preferred from the viewpoints of attaining a sharp particle size distribution and allowing the toner materials to be stably dispersed.

The dispersing agent used in the emulsification or dispersion step is not particularly limited and may be appropriately selected depending on the intended purpose. Examples thereof include anionic surfactants, cationic surfactants, nonionic surfactants, amphoteric surfactants, fluoroalkyl group-containing anionic surfactants, fluoroalkyl group-containing cationic surfactants, inorganic compounds (e.g., tricalcium phosphate, calcium carbonate, titanium oxide, colloidal silica, and hydroxyapatite), polymer particles (e.g., MMA polymer particles of 1 μm and 3 μm, styrene particles of 0.5 μm and 2 μm, and styrene-acrylonitrile polymer particles of 1 μm). Among them, preferred are fluoroalkyl group-containing surfactants from the viewpoint of being capable of exhibiting its dispersing effects even in a very small amount.

An amount of the dispersing agent contained is not particularly limited and may be appropriately selected depending on the intended purpose. In the case of a resin particle dispersion liquid, it is preferably 0.01% by mass to 1% by mass, more preferably 0.02% by mass to 0.5% by mass, particularly preferably 0.1% by mass to 0.2% by mass. When the amount is less than 0.01% by mass, the resin particles may be aggregated with each other in a state at which the emulsion or dispersion has an insufficiently basic pH. The amount of the dispersing agent contained is not particularly limited and may be appropriately selected depending on the intended purpose. In the case of a colorant dispersion liquid or a releasing agent dispersion liquid, it is preferably 0.01% by mass to 10% by mass, more preferably 0.1% by mass to 5% by mass, particularly preferably 0.5% by mass to 0.2% by mass. When the amount is less than 0.01% by mass, some specific particles may be exfoliated from the aggregated particles due to difference of stability between particles upon aggregation. When it is more than 10% by mass, the particle size distribution of the particles may be broadened or the particle diameter may be difficult to be controlled.

Examples of commercially available dispersion agents include SURFLON S-111, S-112, S-113 and S-121 (all products of Asahi Glass Co., Ltd.); FRORARD FC-93, FC-95, FC-98, FC-129 and FC-135 (all products of Sumitomo 3M Ltd.); UNIDYNE DS-101, DS-102 and DS-202 (all products of Daikin Industries, Ltd.); MEGAFACE F-110, F-120, F-113, F-150, F-191, F-812, F-824 and F-833 (all products of DIC, Inc.); EFTOP EF-102, 103, 104, 105, 112, 123A, 123B, 132, 306A, 501, 201 and 204 (all products of Tohchem Products Co., Ltd.); FUTARGENT F-100, F-300 and F150 (all products of NEOS COMPANY LIMITED); SGP and SGP-3G (product of Soken Chemical & Engineering Co., Ltd.); PB-200H (product of Kao Corporation); TECHNO POLYMER SB (product of SEKISUI PLASTICS CO. LTD.) and MICOR PEARL (product of SEKISUI FINE CHEMICAL CO., LTD.).

In the case where the dispersing agent is used, the dispersing agent may remain on the surfaces of the toner particles. However, the dispersing agent is preferably removed by washing after reaction from the viewpoint of chargeability of the formed toner. The dispersing agent is further preferably removed using a solvent in which the modified polyester after reaction of the polyester prepolymer can be dissolved from the viewpoint of attaining a sharp particle size distribution and decreasing the viscosity of the toner materials. The solvent is preferably a volatile solvent having a boiling point of lower than 100° C. from the viewpoint of easiness of removal. Examples thereof include water-miscible solvents such as toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, tetrahydrofuran and methanol. These may be used alone or in combination. Among them, preferred are aromatic solvents such as toluene and xylene; and halogenated hydrocarbons such as methylene chloride, 1,2-dichloroethane, chloroform and carbon tetrachloride.

In the case where the dispersing agent is used, a dispersing stabilizer is preferably used. In the case where a polymeric protective colloid is used as the dispersing stabilizer, the polymeric protective colloid is not particularly limited and may be appropriately selected depending on the intended purpose, so long as it can stabilize dispersed-liquid droplets with, for example, water-insoluble organic particles. Examples thereof include acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing (meth)acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide); vinyl alcohols and ethers thereof (e.g., vinyl methyl ether, vinyl ethyl ether and vinyl propyl ether); esters of vinyl alcohols and carboxyl group-containing compounds (e.g., vinyl acetate, vinyl propionate and vinyl butyrate); acrylamide, methacrylamide, diacetoneacrylamide and methylol compounds thereof; acid chlorides (e.g., acrylic acid chloride and methacrylic acid chloride); homopolymers or copolymers of nitrogen-containing compounds or nitrogen-containing heterocyclic compounds (e.g., vinyl pyridine, vinyl pyrrolidone, vinyl imidazole and ethyleneimine); polyoxyethylenes (e.g., polyoxyethylene, polyoxypropylene, polyoxyethylene alkyl amine, polyoxypropylene alkyl amine, polyoxyethylene alkyl amide, polyoxypropylene alkyl amide, polyoxyethylene nonylphenyl ether, polyoxyethylene laurylphenyl ether, polyoxyethylene stearylphenyl ester and polyoxyethylene nonylphenyl ester); and celluloses (e.g., methyl cellulose, hydroxyethyl cellulose and hydroxypropyl cellulose).

When an acid- or alkali-soluble compound (e.g., calcium phosphate) is used as the dispersion stabilizer, the calcium phosphate used is dissolved with an acid (e.g., hydrochloric acid), followed by washing with water, to thereby remove it from the formed particles. Also, the calcium phosphate may be removed through enzymatic decomposition.

The disperser used in the emulsification or dispersion step is not particularly limited and may be appropriately selected depending on the intended purpose. Examples thereof include a low-speed shearing disperser, a high-speed shearing disperser, a friction disperser, a high-pressure jetting disperser or an ultrasonic disperser. Among them, the high-speed shearing disperser is preferred in that dispersoids (oil droplets) can be controlled so as to have a particle diameter of 2 μm to 20 μm. When the high-speed shearing disperser is used, dispersion conditions such as a rotating speed, a dispersion time or a dispersion temperature are not particularly limited and may be appropriately selected depending on the intended purpose. The rotating speed is not particularly limited and may be appropriately selected depending on the intended purpose, but is preferably 1,000 rpm to 30,000 rpm, more preferably 5,000 rpm to 20,000 rpm. The dispersion time is not particularly limited and may be appropriately selected depending on the intended purpose, but is preferably 0.1 min to 5 min in a batch manner. The dispersion temperature is not particularly limited and may be appropriately selected depending on the intended purpose, but is preferably 0° C. to 150° C., more preferably from 40° C. to 98° C. under pressure. Generally, the higher dispersion temperature is, the easier dispersoids are dispersed.

### --Solvent Removing Step--

The solvent removing step is a step of removing the organic solvent from the emulsion or dispersion (dispersion liquid such as emulsified slurry). A method for removing the organic solvent is not particularly limited and may be appropriately selected depending on the intended purpose. There can be employed a method in which the entire system is gradually increased in temperature to completely evaporate off the organic solvent contained in the oil droplets. Alternatively, there can be employed a method in which the dispersion liquid is sprayed (using, for example, a spray dryer, a belt dryer or a rotary kiln) to a dry atmosphere (heated gas of, for example, air, nitrogen, carbon dioxide or combustion gas), to thereby evaporate off the organic solvent contained in the oil droplets. This method, even in a short time, allows to sufficiently remove the organic solvent. Removal of the organic solvent results in forming the toner base particles.

### --Washing or Drying Step--

The washing or drying step is a step of washing or drying the toner base particles. The toner base particles may be further classified.

The toner base particles may be classified by removing particles using, for example, a cyclone, a decanter or a centrifuge in liquid. Alternatively, post-dried toner base particles may be classified. Notably, fine or coarse particles that have been removed by classifying may be used again for forming particles. In this case, these fine or coarse particles may be in a wet state.

### --External Additive Treatment Step--

The external additive treatment step is a step of mixing and treating post-dried toner base particles with the external additive containing the coalesced particles which meet a specific parameter defined in the present invention. Mixing the toner base particles with the external additive results in the toner of the present invention. A device used in the mixing is not particularly limited and may be appropriately selected depending on the intended purpose, but is preferably HENSCHEL MIXER (product of NIPPON COKE & ENGINEERING COMPANY, LIMITED.) Notably, mechanical impact can be applied in order to prevent the external additive from being exfoliated from the surfaces of the toner base particles. A method for applying mechanical impact is not particularly limited and may be appropriately selected depending on the intended purpose. Examples thereof include a method in which impact is applied to a mixture using a high-speed rotating blade and a method in which a mixture is caused to pass through a high-speed airflow for acceleration to thereby allow particles to collide with each other or with an appropriate collision plate. A device used in applying mechanical impact is not particularly limited and may be appropriately selected depending on the intended purpose. Examples thereof include ONGMILL (product of Hosokawa Micron Corp.), a modified I-type mill (product of Nippon Neumatic Co., Ltd.) so as to reduce the pulverizing air pressure, HYBRIDIZATION SYSTEM (product of Nara Machinery Co., Ltd.), CRYPTRON SYSTEM (production of Kawasaki Heavy Industries, Ltd.) and an automatic mortar.

### <<Toner Property>>

A ratio (Dw/Dn) of a mass average particle diameter (Dw) to a number average particle diameter (Dn) of the toner is not particularly limited and may be appropriately selected depending on the intended purpose. The ratio (Dw/Dn) is preferably 1.30 or less, more preferably 1.00 to 1.30. When the ratio (Dw/Dn) is less than 1.00, the following problems occur. Specifically, for a two-component developer, when stirring for a long period of time in a developing device, the toner is fused to a surface of a carrier, possibly leading to lowered charging ability of the carrier and deteriorated cleanability. For a one-component developer, it is likely to cause a filming of the toner on a developing roller and to fuse the toner on a member such as a blade for thinning a toner layer. When the ratio (Dw/Dn) exceeds 1.30, high-quality images with a high resolution cannot be formed without difficulties. In this case, when the toner is introduced and consumed in a developer, a fluctuation in particle diameters of the toner may be increased.

An average circularity of the toner is not particularly limited and may be appropriately selected depending on the intended purpose, but is preferably 0.94 to 0.99. When the average circularity of the toner is less than 0.94, evenness of an image in the development is deteriorated, or the transfer efficiency of the toner from an electrophotographic photoconductor to an intermediate transfer member or from the intermediate transfer member to a recording medium may be lowered. Consequently, uniform transfer cannot be realized in some cases. According to the present invention, the toner is produced by emulsification treatment in the aqueous medium. This process is effective in reducing particle diameters and in realizing a toner having the average circularity in the above-defined range, especially in a color toner. The average circularity can be measured using, for example, a flow-type particle image analyzer FPIA-2000 (product of Sysmex Corp.). One specific method for measuring the average circularity is as follows: a predetermined vessel is charged with water (100 mL to 150 mL) from which solid impurities have previously been removed. To the vessel were added a surfactant (0.1 mL to 0.5 mL) serving as a dispersing agent, and a measurement sample (about 0.1 g to about 9.5 g) to thereby obtain a suspension liquid in which the sample is dispersed. The suspension liquid is dispersed with an ultrasonic disperser for about 1 min to about 3 min so as to have a concentration of 3,000 particles/μL to 10,000 particles/μL to thereby measure for shape and distribution using the above analyzer.

### (Developer)

A developer of the present invention contains at least the toner of the present invention; and, if necessary, further contains other ingredients. The developer may be a one-component developer or a two-component developer. In the case that the developer is a two-component developer, a mixture of the toner of the present invention and a carrier may be used. In the case that the developer is a one-component developer, the toner of the present invention may be used as a one-component magnetic or non-magnetic toner.

The developer is preferably a two-component developer containing at least the toner of the present invention and the carrier.

### <Carrier>

The carrier includes magnetic core particles and a coating resin which coats the core particles; and, if necessary, further includes electroconductive powder and a silane coupling agent. The particle diameters of the carrier and of the core particles serving as carrier skeleton are important factors.

A content ratio of the carrier to the toner is not particularly limited and may be appropriately selected depending on the intended purpose. The carrier is preferably included in an amount of 1 part by mass to 10 parts by mass, per 100 parts by mass of the carrier.

The mass average particle diameter of the carrier is not particularly limited and may be appropriately selected depending on the intended purpose, but is preferably 15 μm to 40 μm. When the mass average particle diameter is smaller than 15 μm, carrier adhesion, which is a phenomenon that the carrier is also disadvantageously transferred in a transfer step, is likely to occur. When the mass average particle diameter is larger than 40 μm, the carrier adhesion is less likely to occur. However, when the toner density is increased in order to provide a high image density, there is a possibility that background smear is likely to occur. Further, when a dot diameter of a latent image is small, variation in dot reproducibility is so large that granularity in highlight parts may be deteriorated.

### -Core Particles-

The core particles are not particularly limited and may be appropriately selected depending on the intended purpose, so long as it has magnetization of 40 emu/g or more when a magnetic field of 1,000 oersteds (Oe) is applied to the carrier. Examples thereof include ferromagnetic materials such as iron and cobalt; magnetite, hematite, Li based ferrite, Mn—Zn based ferrite, Cu—Zn based ferrite, Ni—Zn based ferrite, Ba based ferrite and Mn based ferrite. Crushed particles of a magnetic material can be used as the core particles. When the core particles are made of ferrite or magnetite, primarily granulated product of pre-sintered particles are classified and sintered, and the sintered particles are then classified into particulate powders having different particle size distributions, and a plurality of the particulate powders are mixed to thereby obtain the core particles.

A method of classifying the core particles is not particularly limited and may be appropriately selected depending on the intended purpose. Examples thereof include conventional known classifying methods using, for example, sieve machines, gravitational classifiers, centrifugal classifiers and inertial classifiers. Among them, preferred are air classifiers such as gravitational classifiers, centrifugal classifiers and inertial classifiers.

### -Coating Resin-

The coating resin is not particularly limited and may be appropriately selected depending on the intended purpose. Examples thereof include amino-based resins, urea-formaldehyde resins, melamine resins, guanamine resins, urea resins, polyamide resins, polyvinyl resins, polyvinylidene-based resins, acrylic resins, polymethyl methacrylate resins, polyacrylonitrile resins, polyvinyl acetate resins, polyvinyl alcohol resins, polyvinyl butyral resins, polystyrene resins, polystyrene-based resins (e.g., styrene-acrylic copolymers resins), halogenated olefin resins (e.g., polyvinyl chloride resins), polyester-based resins, polyethylene terephthalate resins, polybutyrene terephthalate resins, polycarbonate-based resins, polyethylene resins, polyvinyl fluoride resins, polyvinylidene fluoride resins, polytrifluoroethylene resins, polyhexafluoropropylene resins; copolymers of vinylidene fluoride and an acrylic monomer; copolymers of vinylidene fluoride and vinyl fluoride; fluoroterpolymers (e.g., terpolymers of tetrafluoroethylene, vinylidene fluoride and a non-fluorinated monomer); silicone resins and epoxy resin. These may be used alone or in combination. Among them, preferred are silicone resins.

### -Method for Producing Carrier-

A method for producing the carrier is not particularly limited and may be appropriately selected depending on the intended purpose. Example thereof includes a method in which coating layers are formed on surfaces of the core particles. The method for forming coating layers on surfaces of the core particles is not particularly limited and may be appropriately selected depending on the intended purpose. Examples thereof include a spray-dry method, an immersion method, and a power-coating method. Among them, a method using a fluidized bed coating apparatus is preferred from the viewpoint of forming a uniform coating layer.

### (Process Cartridge)

A process cartridge is used for the image forming apparatus of the present invention. The process cartridge includes a latent electrostatic image bearing member (electrophotographic photoconductor) and a developing unit configured to develop using the toner of the present invention to thereby form a visible image, and can be detachably attached to the image forming apparatus of the present invention.

### (Image Forming Method and Image Forming Apparatus)

An image forming apparatus of the present invention includes at least a latent electrostatic image bearing member (electrophotographic photoconductor), a latent electrostatic image forming unit, a developing unit, a transfer unit and a fixing unit; preferably further includes a toner transporting unit; and, if necessary, includes other units. The image forming apparatus use the toner of the present invention in the developing unit. Notably, the latent electrostatic image forming unit is a combination of a charging unit and an exposing unit.

The image forming method includes at least a latent electrostatic image forming step, a developing step, a transfer step and a fixing step; preferably further include a toner transporting step; and, if necessary, includes other steps. The image forming method uses the toner of the present invention in the developing step. Notably, the latent electrostatic image forming step is a combination of a charging step and an exposing step.

### <Latent Electrostatic Image Forming Step and Latent Electrostatic Image Forming Unit>

The latent electrostatic image forming step is a step of forming a latent electrostatic image on the latent electrostatic image bearing member, and is performed using the latent electrostatic image forming unit. A linear velocity of the latent electrostatic image bearing member is not particularly limited and may be appropriately selected depending on the intended purpose, but is preferably 300 mm/sec or more. In the latent electrostatic image bearing member, for example, its material, shape, structure or size is not particularly limited and may be appropriately selected depending on the intended purpose. Examples of the material include inorganic materials such as amorphous silicon or selenium; and organic materials such as polysilane or phthalopolymethine. Among them, amorphous silicon is preferably used from the viewpoint from attaining a long service life. Suitable example of the shape includes a drum shape. The latent electrostatic image forming unit is a combination unit of a charging unit and an exposing unit. The charging unit is not particularly limited and may be appropriately selected depending on the intended purpose. Examples thereof include contact-type chargers known per se having, for example, an electroconductive or semielectroconductive roller, brush, film and rubber blade; and non-contact-type chargers utilizing colona discharge such as corotron or scorotron. The exposing unit is not particularly limited and may be appropriately selected depending on the intended purpose. Examples of the exposing unit include various exposing units such as a copy optical exposing unit, a rod lens array exposing unit, a laser optical exposing unit, a liquid crystal shutter exposing unit, and an LED optical exposing unit. Examples of a light source used for the exposing unit include those capable of securing high luminance, such as a light-emitting diode (LED), a semiconductor laser (LD) and an electroluminescence (EL) device.

### <Developing Step and Developing Unit>

The developing step is can be performed using the developing unit and is a step of developing the latent electrostatic image with a toner to thereby form a visible image. The developing unit is not particularly limited and may be appropriately selected depending on the intended purpose. For example, the developing unit is not particularly limited and may be appropriately selected depending on the intended purpose, so long as it can perform a development using the toner and the developer of the present invention. Suitable example of the developing unit includes those having at least a developing device which contains the developer therein and can apply the developer to the latent electrostatic image in a contact or non-contact manner. The developing device may employ a dry or wet developing process, and may be a single-color or multi-color developing device. Suitable example of the developing device includes those having a rotatable magnetic roller and a stirrer configured to charge the developer with friction stirring. In the developing device, the toner of the present invention are stirred and mixed with the carrier, so that the toner is charged by friction generated therebetween. The charged toner is retained in a chain-like form on a surface of the rotating magnetic roller to thereby form a magnetic brush. The magnetic roller is disposed proximately to the electrophotographic photoconductor. Accordingly, some of the toner of the present invention which constitutes the magnetic brush formed on the surface of the magnet roller are transferred onto a surface of the electrophotographic photoconductor by the action of electrically attractive force. As a result, the latent electrostatic image is developed with the toner to thereby form a visual toner image on the surface of the electrophotographic photoconductor.

### <Transfer Step and Transfer Unit>

The transfer step can be performed using the transfer unit, and is a step of transferring the visible image onto a recording medium. The transfer unit is a unit configured to transfer the visible image onto a recording medium. Examples of a method for transferring the visible image onto the recording medium include a method in which the visible image is directly transferred from a surface of the electrophotographic photoconductor to the recording medium and a method in which the visible image is primarily transferred to an intermediate transfer member and then secondarily transferred to the recording medium. The latter method is preferred. At this step, usually two or more color toners are used, and preferably full-color toner is used. Accordingly, the transfer step more preferably includes a primary transfer step of transferring visible images onto an intermediate transfer medium to form a composite transfer image, and a secondary transfer step of transferring the composite transfer image onto a recording medium. Notably, in the secondary transfer step, a linear velocity of transfer of the toner image onto the recording medium is not particularly limited and may be appropriately selected depending on the intended purpose. It is preferably 300 mm/sec to 1,000 mm/sec. The transfer time at a nip part in a secondary transfer unit is not particularly limited and may be appropriately selected depending on the intended purpose, but is preferably 0.5 msec to 20 msec.

### <Fixing Step and Fixing Unit>

The fixing step is performed using the fixing unit, and is a step of fixing a transfer image which has been transferred onto the recording medium. The fixing unit is not particularly limited and may be appropriately selected depending on the intended purpose, but preferably is a heating-pressing unit. Examples of the heating-pressing unit include: a combination of a heating roller and a pressing roller; and a combination of a heating roller, a pressing roller and an endless belt. Usually, the heating is preferably performed at 80° C. to 200° C. The fixing may be performed every after a toner image of each color is transferred onto the recording medium; or the fixing may be performed at one time after toner images of all colors are superposed on top of one another on the recording medium.

### <Toner Transporting Step and Toner Transporting Unit>

The toner transporting step can be performed using the toner transporting unit, and is a step of supplying the toner from a toner housing container to the developing unit depending on an amount of toner consumed at an image formation. The toner transporting unit is a unit of supplying the toner from a toner housing container to the developing unit depending on an amount of toner consumed at an image formation.

### <Other Steps and Other Units>

The other steps and the other units are not particularly limited and may be appropriately selected depending on the intended purpose. Examples thereof include: a charge-eliminating step and a charge-eliminating unit; a cleaning step and a cleaning unit; a recycling step and a recycling unit; and a controlling step and a controlling unit.

### -Charge-Eliminating Step and Charge-Eliminating Unit-

The charge-eliminating step can be performed using the charge-eliminating unit and is a step of applying charge-eliminating bias to the electrophotographic photoconductor to thereby charge-eliminate the electrophotographic photoconductor. The charge-eliminating unit is not particularly limited and may be appropriately selected from known charge-eliminating devices, so long as it can apply charge-eliminating bias to the electrophotographic photoconductor. Example thereof includes a charge-eliminating lamp.

### -Cleaning Step and Cleaning Unit-

The cleaning step can be performed using the cleaning unit, and is a step of removing the toner remaining on the electrophotographic photoconductor. The cleaning unit is not particularly limited and may be appropriately selected from known cleaners, so long as it can remove the toner remaining on the electrophotographic photoconductor. Examples thereof include magnetic blush cleaners, electrostatic brush cleaners, magnetic roller cleaners, blade cleaners, brush cleaners and web cleaners.

### -Recycling Step and Recycling Unit-

The recycling step can be performed using the recycling unit, and is a step of recycling the toner removed in the cleaning step to the developing unit. The recycling unit is not particularly limited. Examples thereof include known conveyance units.

### -Controlling Step and Controlling Unit-

The controlling step can be performed using the controlling unit, and is a step of controlling each of the above steps. The controlling unit is not particularly limited and may be appropriately selected depending on the purpose, so long as it can control the operation of each of the above units. Examples thereof include devices such as a sequencer and a computer.

### [Embodiments of Image Forming Apparatus]

Next will be described embodiments of the image forming apparatus of the present invention with reference to the appended drawings.

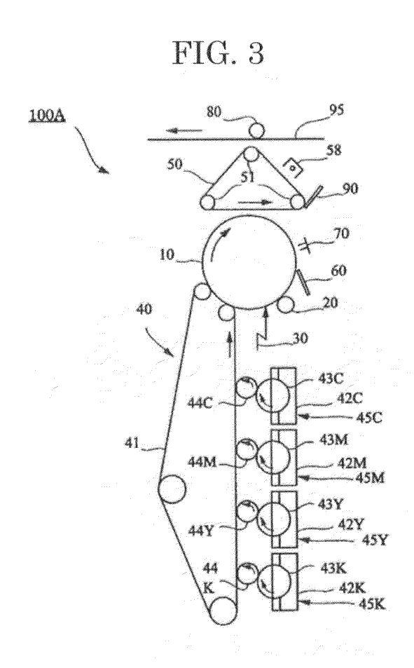

FIG. 3 illustrates one exemplary image forming apparatus used in the present invention. An image forming apparatus 100A includes a photoconductor drum 10 serving as the image bearing member, a charging device 20 serving as the charging unit, an exposing device 30 serving as the exposing unit, a developing device 40 serving as the developing unit, an intermediate transfer member 50, a cleaning device 60 serving as the cleaning unit, and a charge-eliminating lamp 70 serving as the charge-eliminating unit.

The intermediate transfer member 50 shown in FIG. 3 is an endless belt and is extended over three rollers 51 so as to be driven in a direction indicated by an arrow. Some of the three rollers 51 serve also as a transfer bias roller which is capable of applying a predetermined transfer bias (primary transfer bias) to the intermediate transfer member 50. A cleaning device 90 having a cleaning blade is disposed in the vicinity of the intermediate transfer member 50. Also, a transfer roller 80 is disposed so as to face the intermediate transfer member 50 and serves as a transfer unit which is capable of applying a transfer bias for transferring (secondarily transferring) a visible image (toner image) onto a recording medium 95. Around the intermediate transfer member 50, a corona charger 58 for applying charges to the toner image on the intermediate transfer member 50 is disposed between a contact portion of the photoconductor 10 with the intermediate transfer member 50 and a contact portion of the intermediate transfer member 50 with the recording medium (transfer paper) 95 in a rotating direction of the intermediate transfer member 50.

The developing device 40 shown in FIG. 3 includes a developing belt 41 serving as a developer bearing member; and a black developing device 45K, a yellow developing device 45Y, a magenta developing device 45M and a cyan developing device 45C, these devices being arranged in a row around the developing belt 41. The black developing device 45K includes a developer accommodating section 42K, a developer supplying roller 43K, and a developing roller 44K. The yellow developing device 45Y includes a developer accommodating section 42Y, a developer supplying roller 43Y, and a developing roller 44Y. The magenta developing device 45M includes a developer accommodating section 42M, a developer supplying roller 43M, and a developing roller 44M. The cyan developing device 45C includes a developer accommodating section 42C, a developer supplying roller 43C, and a developing roller 44C. The developing belt 41 is an endless belt and is extended over a plurality of belt rollers so as to be capable of being driven in a direction indicated by an arrow, a part of which are in contact with the photoconductor 10.

In the image forming apparatus 100A shown in FIG. 3, the charging device 20 uniformly charges the photoconductor 10. And then, the photoconductor 10 is exposed by the exposing device 30 to thereby form a latent electrostatic image. Next, the latent electrostatic image formed on the photoconductor 10 is developed with a toner supplied from the developing device 40 to thereby form a toner image. The toner image is transferred (primary transferred) onto the intermediate transferring member 50 with a voltage applied by the rollers 51. The thus-transferred image is transferred (secondary transferred) onto the recording paper 95. As a result, the transfer image is formed on the recording paper 95. Notably, the toner remaining on the photoconductor 10 are removed by the cleaning device 60 having a cleaning blade, and charges on the photoconductor 10 are removed by the charge-eliminating lamp 70.

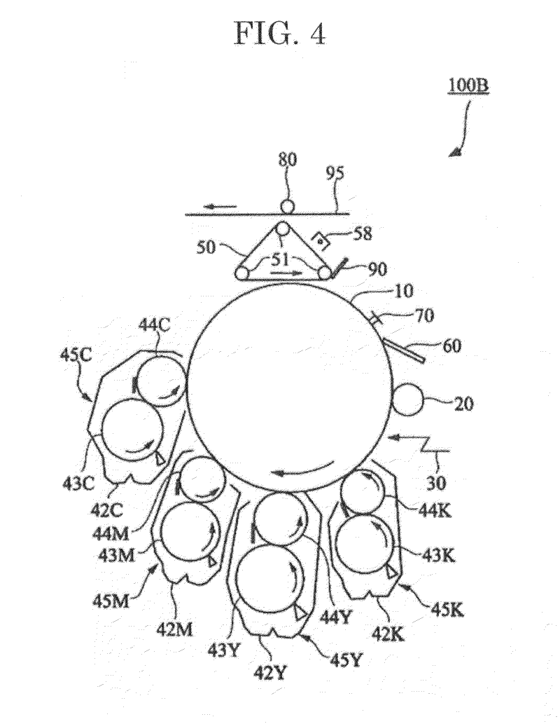

FIG. 4 illustrates another exemplary image forming apparatus used in the present invention. The image forming apparatus 100B has the same configuration and the same function as the image forming apparatus 100A, except that there is no developing belt 41; and a black developing device 45K, a yellow developing device 45Y, a magenta developing device 45M and a cyan developing device 45C are arranged around the photoconductor 10. Note that common members to both in FIGS. 3 and 4 are indicated by the same reference numerals.

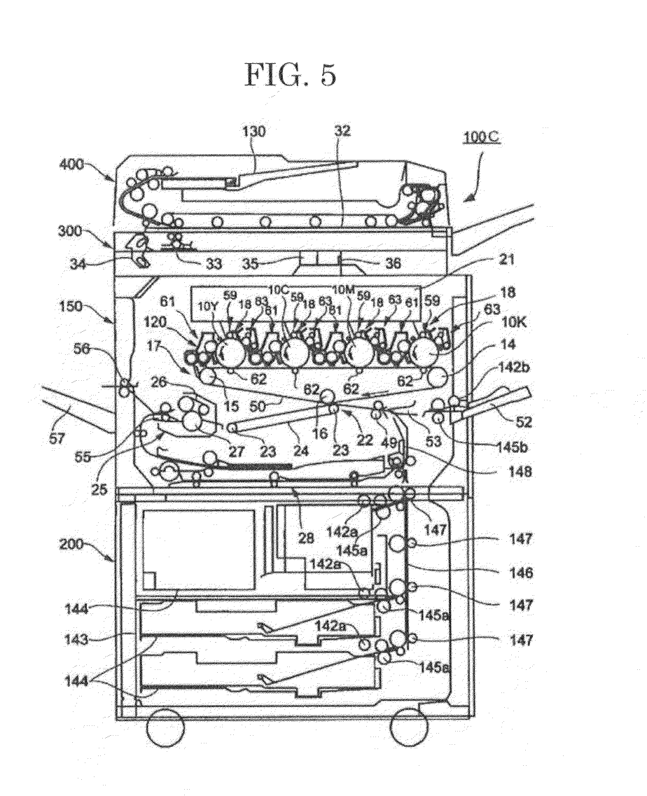

FIG. 5 illustrates another exemplary image forming apparatus used in the present invention. An image forming apparatus 100C is a tandem color image forming apparatus. The image forming apparatus 100C includes a copying device main body 150, a paper feeding table 200, a scanner 300 and an automatic document feeder 400. The copying device main body 150 is provided at its center portion with an endless belt-shaped intermediate transferring member 50. In this figure, the intermediate transfer member 50 is extended over supporting rollers 14, 15 and 16 so as to be capable of clockwise rotating. An intermediate transfer member-cleaning device 17 for removing the toner remaining on the intermediate transfer member 50 is disposed in the vicinity of the supporting roller 15. Around the intermediate transfer member 50 which is extended over the supporting rollers 14 and 15 is provided a tandem developing device 120 in which four image forming units 18 for yellow toner, cyan toner, magenta toner and black toner are arranged in a row along a moving direction of the intermediate transfer member. An exposing device 21 is provided in the vicinity of the tandem developing device 120. A secondary transfer device 22 is provided on the intermediate transfer member 50 on the side opposite to the side on which the tandem developing device 120 is disposed. In the secondary transfer device 22, an endless belt-shaped secondary transfer belt 24 is extended over a pair of supporting rollers 23. A recording paper which is conveyed on the secondary transfer belt 24 can come into contact with the intermediate transfer member 50. A fixing device 25 is provided in the vicinity of the secondary transfer device 22. The fixing device 25 includes an endless fixing belt 26 and a pressing roller 27 disposed so as to be pressed against the fixing belt 26. Notably, in the image forming apparatus 100C, a sheet reversing device 28 for reversing the transfer paper is disposed in the vicinity of the secondary transfer device 22 and the fixing device 25. The sheet reversing device allows images to be formed on both sides of the recording paper.

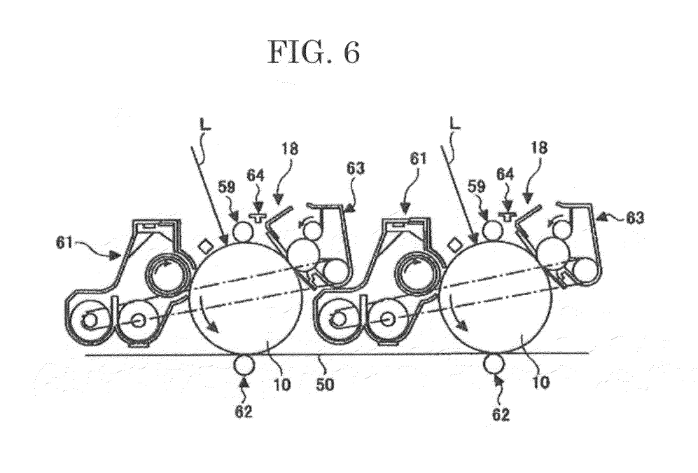

FIG. 6 illustrates formation of a full color image (color copy) using the tandem developing device 120 as another exemplary image forming apparatus used in the present invention. Note that common members to both in FIGS. 5 and 6 are indicated by the same reference numerals. Each of the image forming units 18 in the tandem developing device 120 includes a photoconductor 10; a charger 59 for uniformly charging the photoconductor 10; an exposing device 21 for exposing the photoconductor 10 to light (indicated by a symbol L in FIG. 6) based on image information corresponding to black, yellow, magenta and cyan to thereby form a latent electrostatic image corresponding to each of black, yellow, magenta and cyan on the photoconductor 10; a developing device 61 for developing the latent electrostatic image with each color toner to thereby form each color toner image on the photoconductor 10; a transfer charger 62 for transferring the color toner image onto the intermediate transfer member 50; a cleaning device 63 for photoconductor; and a charge-eliminating device 64.

In the tandem developing device 120 shown in FIG. 6, firstly, an original document is set on a document table 130 of an automatic document feeder 400. Alternatively, the automatic document feeder 400 is opened and then an original document is set on a contact glass 32 of the scanner 300, followed by closing the automatic document feeder 400. In the former case, when a starting switch (not illustrated) is pressed, the scanner 300 is operated to run a first carriage 33 and a second carriage 34 after the original document has been conveyed onto the contact glass 32. In the latter case, when a starting switch (not illustrated) is pressed, the scanner 300 is operated to run a first carriage 33 and a second carriage 34 immediately after the original document has been set on the contact glass 32. At that time, the first carriage 33 irradiates light to the original document, and then the second carriage 34 reflects, on its mirror, light reflected by the original document. The thus-reflected light is received by a reading sensor 36 through an imaging lens 35. Thus, the original document (color image) is read to thereby form image information corresponding to black, yellow, magenta and cyan. The image information is transferred to a corresponding image forming unit 18 in the tandem developing device 120 to thereby form a toner image of each of black, yellow, magenta and cyan. A black image formed on the black photoconductor 10K, a yellow image formed on the yellow photoconductor 10Y, a magenta image formed on the magenta photoconductor 10M, and a cyan image formed on the cyan photoconductor 10C are sequentially transferred (primarily transferred) onto the intermediate transfer member 50. Then, the black, yellow, magenta and cyan images are superposed on the intermediate transfer member 50 to thereby form a composite color image (transferred color image).

In a paper feeding table 200 shown in FIG. 6, one of paper feeding rollers 142a is selectively rotated to thereby feed recording paper from one of vertically stacked paper feeding cassettes 144 housed in a paper bank 143. The thus-fed sheets of paper are separated one another by a separating roller 145a. The thus-separated sheet is fed through a paper feeding path 146, then fed through a paper feeding path 148 in a copying device main body 150 by a transfer roller 147, and stopped at a resist roller 49. Alternatively, paper feeding rollers 142b are rotated to thereby feed recording paper placed on a manual-feeding tray 52. The thus-fed sheets of paper are separated one another by a separating roller 145b. The thus-separated sheet is fed through a manual paper-feeding path 53 and then stopped at a resist roller 49 similar to the above. Notably, the resist roller 49 is generally connected to the ground in use. Alternatively, the resist roller 49 may be used with being applied by a bias for removing paper dust from the sheet. The resist roller 49 is rotated to thereby feed recording paper to between the intermediate transfer member 50 and the secondary transfer device 22 in synchronization with the transferred color image formed on the intermediate transfer member 50, whereby the transferred color image is formed on the recording paper. The recording paper having the transferred color image is fed by the secondary transfer device 22 to a fixing device 25. The fixing device 25 fixes the transferred color image on the recording paper through application of heat and pressure. Subsequently, the recording paper is discharged from a discharge roller 56 by a switching claw 55 and then stacked on a discharge tray 57. Alternatively, the recording paper is switched by a switching claw 55 and reversed by a sheet reversing device 28. The reversed paper is fed again to the transfer position where an image is transferred on the back surface of the paper. The paper is discharged from a discharge roller 56 and then stacked on a discharge tray 57. Notably, the toner remaining on the intermediate transfer member 50 after image transfer is removed by an intermediate transfer member-cleaning device 17.

The preferred embodiments of the present invention have been explained above, but the present invention is not limited thereto and may be variously modified.

### EXAMPLES

The present invention now will be described in detail by way of Examples and Comparative Examples, which should not be construed as limiting the present invention thereto. Unless otherwise specified, in Examples, the unit “part(s)” means “part(s) by mass” and the unit “%” means “% by mass.”

### (Production of External Additives)

External additives a to r were produced as follows. A treatment agent was mixed with primary silica particles with varying average particle diameters shown in Table 2 using a spray drier. The resultant mixture was baked to thereby allow the primary particles to coalesce with each other. Further, the resultant coalesced particles were classified with a classification device to thereby prepare coalesced particles with varying average particle diameters shown in Table 2 in order to obtain external additives having sharp particle size distributions.

### <Various Measurement>

With regard to the coalesced particles (secondary particles), Db₅₀ was determined as a particle diameter of the coalesced particle at which the cumulative percentage is 50% by number, and Db₁₀ was determined as a particle diameter of the coalesced particle at which the cumulative percentage is 10% by number in a distribution diagram in which the coalesced particles are accumulated from the coalesced particles having smaller particle diameters to the coalesced particles having larger particle diameters.

The particle diameters of primary particles in the coalesced particles were determined by measuring for maximum diameters of the primary particles which are aggregated together (the lengths of all the arrows shown in FIG. 1, the number of measured particles: 150). The average particle diameter of the primary particles in the coalesced particles was determined by averaging the above measured particle diameters.

The particle diameters of the coalesced particles (secondary particles) were determined by measuring for maximum diameters of whole shapes of the coalesced particles (the length of an arrow shown in FIG. 2, the number of measured particles: 150). The whole shape was expected based on a periphery of the coalesced silica particles. The average particle diameter of the coalesced particles was determined by averaging the above measured particle diameters.

The particle diameter of each of these particles was measured as follows. Firstly, the coalesced particles were dispersed in an appropriate solvent (e.g., tetrahydrofuran (THF)). The resultant dispersion liquid was subjected to solvent removal to dryness on a substrate to thereby obtain a measurement sample. The measurement sample was observed under a field emission type scanning electron microscope (FE-SEM, S-5200, product of Hitachi, Ltd., acceleration voltage: 5 kV, observed magnification: 10,000), and measured for the particle diameters of the coalesced particles within one field of vision.

The rate of the coalesced particles having the degree of coalescence of less than 1.3 contained was calculated as follows. At first, 150 of coalesced particles were measured for particle diameters of the primary and secondary particles. Based on the obtained particle diameters, the degree of coalescence for each of coalesced particles was calculated. The number of the particles having the degree of coalescence of less than 1.3 was divided by the number of the measured particles (i.e., 150).

TABLE 2

| | External Additives | | | | | | | |
|---|---|---|---|---|---|---|---|---|
| | Properties of coalesced particles | | | | | | | |
| | | Average | Average | | | | | |
| | | particle | particle | Parameters of coalesced particles | | | | |
| | | diameter of | diameter of | | | | Average of | G < 1.3 |
| | Inorganic | primary | secondary | | | | degrees of | Number of |
| | particles | particles | particles | Db₁₀ | Db₅₀ | Db₅₀/ | coalescence | particles |
| | (type) | (Da) (nm) | (Db) (nm) | (nm) | (nm) | Db₁₀ | G | (% by number) |
| a | silica | 43 | 100 | 84 | 96 | 1.14 | 2.3 | 6 |
| b | silica | 53 | 85 | 69 | 82 | 1.19 | 1.6 | 12 |
| c | silica | 53 | 74 | 60 | 70 | 1.17 | 1.4 | 8 |
| d | silica | 21 | 76 | 67 | 80 | 1.19 | 3.7 | 16 |
| e | silica | 59 | 213 | 182 | 206 | 1.13 | 3.6 | 7 |
| f | silica | 64 | 90 | 71 | 85 | 1.20 | 1.4 | 12 |
| g | silica | 147 | 176 | 152 | 174 | 1.14 | 1.2 | 7 |
| h | silica | 22 | 92 | 76 | 90 | 1.18 | 4.2 | 11 |
| i | silica | 36 | 172 | 148 | 168 | 1.14 | 4.8 | 9 |
| j | silica | 47 | 206 | 168 | 200 | 1.19 | 4.4 | 12 |
| k | silica | 47 | 112 | 86 | 105 | 1.22 | 2.4 | 9 |
| l | silica | 105 | 210 | 162 | 201 | 1.24 | 2.0 | 7 |
| m | silica | 20 | 88 | 62 | 82 | 1.32 | 4.4 | 7 |
| n | silica | 61 | 195 | 150 | 188 | 1.25 | 3.2 | 15 |
| o | silica | 98 | 137 | 102 | 130 | 1.27 | 1.4 | 17 |
| p | silica | 53 | 222 | 168 | 216 | 1.29 | 4.2 | 10 |
| q | silica | 30 | 78 | 57 | 74 | 1.30 | 2.6 | 14 |
| r | silica | 58 | 76 | 58 | 70 | 1.21 | 1.3 | 18 |

### Synthesis Example 1

### Synthesis of Crystalline Polyester Resin 1 (Unmodified Polyester Resin)

A 5 L four-neck flask equipped with a nitrogen-introducing pipe, a drainpipe, a stirrer and a thermocouple was charged with 1,6-hexanediol (2,300 g), fumaric acid (2,530 g), trimellitic anhydride (291 g) and hydroquinone (4.9 g), followed by reaction at 160° C. for 5 hours. Thereafter, the reaction mixture was allowed to react at 200° C. for 1 hour and further react at 8.3 kPa for 1 hour, to thereby obtain [crystalline polyester resin 1]. [Crystalline polyester resin 1] was found to have an endothermic peak temperature of 120° C. (measured by DSC), a number average molecular weight (Mn) of 1,500, a mass average molecular weight (Mw) of 9,000, and a SP value of 10.8.

### Synthesis Example 2

### Synthesis of Crystalline Polyester Dispersion Liquid 1 (Unmodified Polyester Resin)

[Crystalline polyester resin 1] (100 g) and ethyl acetate (400 g) were added to a 2 L metal container. The resultant mixture was dissolved at 75° C. under heating and then quenched in an ice-water bath at a temperature decreasing rate of 27° C./min. Subsequently, glass beads (3 mm in diameter) (500 mL) were added to the mixture, followed by pulverizing for 10 hours with a batch-type sand mill (product of Kanpe Hapio Co., Ltd.), to thereby obtain [crystalline polyester dispersion liquid 1].

### Synthesis Example 3

### Synthesis of Non-Crystalline Polyester Resin 1 (Unmodified Polyester Resin)

A 5 L four-neck flask equipped with a nitrogen-introducing pipe, a drainpipe, a stirrer and a thermocouple was charged with bisphenol A ethylene oxide 2 mole adduct (229 parts), bisphenol A propylene oxide 3 mole adduct (529 parts), terephthalic acid (208 parts), adipic acid (46 parts) and dibutyltin oxide (2 parts). The reaction mixture was allowed to react under a normal pressure at 230° C. for 7 hours and further react under a reduced pressure of 10 mmHg to 15 mmHg for 4 hours. Then, trimellitic anhydride (44 parts) was added to the flask, followed by reaction at 180° C. under a normal pressure for 2 hours, to thereby obtain [non-crystalline polyester resin 1].

### Synthesis Example 4

### Synthesis of Unmodified Polyester Resin 1

A reaction container equipped with a condenser, a stirrer and a nitrogen-introducing pipe was charged with bisphenol A ethylene oxide 2 mole adduct (67 parts), bisphenol A propylene oxide 3 mole adduct (84 parts), terephthalic acid (274 parts), and dibutyltin oxide (2 parts). The resultant mixture was allowed to react under a normal pressure at 230° C. for 8 hours and further react at a reduced pressure of 10 mmHg to 15 mmHg for 5 hours, to thereby synthesize [unmodified polyester resin 1]. Thus obtained [unmodified polyester resin 1] was found to have a number average molecular weight (Mn) of 2,100, a mass average molecular weight (Mw) of 5,600, and a glass transition temperature (Tg) of 55° C.

### Synthesis Example 5

### Synthesis of Polyester Prepolymer

A reaction container equipped with a condenser, a stirrer and a nitrogen-introducing pipe was charged with bisphenol A ethylene oxide 2 mole adduct (682 parts), bisphenol A propylene oxide 2 mole adduct (81 parts), terephthalic acid (283 parts), trimellitic anhydride (22 parts) and dibutyltin oxide (2 parts). The resultant mixture was allowed to react under a normal pressure at 230° C. for 8 hours and further react at a reduced pressure of 10 mmHg to 15 mmHg for 5 hours, to thereby obtain [intermediate polyester 1]. Thus obtained [intermediate polyester 1] was found to have a number average molecular weight of 2,100, a mass average molecular weight of 9,500, a Tg of 55° C., an acid value of 0.5 and a hydroxyl value of 51. Next, a reaction container equipped with a condenser, a stirrer and a nitrogen-introducing pipe was charged with [intermediate polyester 1] (410 parts), isophorone diisocyanate (89 parts) and ethyl acetate (500 parts), followed by reaction at 100° C. for 5 hours, to thereby produce [prepolymer 1]. The rate of free isocyanate contained in [prepolymer 1] was found to be 1.53% by mass.

### Synthesis Example 6

### Synthesis of Ketimine Compound 1

A reaction container equipped with a stirring rod and a thermometer was charged with isophorone diamine (170 parts) and methyl ethyl ketone (75 parts), followed by reaction at 50° C. for 5 hours, to thereby obtain [ketimine compound 1]. An amine value of [ketimine compound 1] was found to be 418.

### Synthesis Example 7

### Synthesis of Masterbatch 1 (MB)

Water (1,000 parts), carbon black (PRINTEX 35, product of Evonik Degussa Japan Co., Ltd.) [DBP oil absorption amount=42 mL/100 mg, pH=9.5] (540 parts) and [unmodified polyester resin 1] (1,200 parts) were mixed together using HENSCHEL MIXER (product of NIPPON COKE & ENGINEERING COMPANY, LIMITED.) The resultant mixture was kneaded at 150° C. for 30 min using a two-roller mill, and then rolled, cooled and pulverized with a pulverizer (product of Hosokawa Micron Corp.), to thereby prepare [masterbatch 1].

### Example 1

### <Production of Toner Base Particles A (Ester Elongation Method)>

### -Preparation of Oil Phase-

A container equipped with a stirring rod and a thermometer was charged with [non-crystalline polyester resin 1] (378 parts), carnauba wax (110 parts), a charge controlling agent (CCA, salicylic acid metal complex E-84: product of Orient Chemical Industries, Ltd.) (22 parts) and ethyl acetate (947 parts). The resultant mixture was heated to 80° C. under stirring, maintained at 80° C. for 5 hours and then cooled to 30° C. for 1 hour. Subsequently, [masterbatch 1] (500 parts) and ethyl acetate (500 parts) were charged into the container, followed by mixing for 1 hour, to thereby obtain [raw material solution 1]. [Raw material solution 1] (1,324 parts) was placed in a container. Carbon black and wax were dispersed using a beads mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed in 80% by volume, and 3 passes. Next, a 65% by mass ethyl acetate solution of the [non-crystalline polyester resin 1] (1,042.3 parts) was added thereto, and passed once through the beads mill under the above conditions, to thereby obtain [oil phase 1]. The solid content of [oil phase 1] was found to be 50% by mass (130° C., 30 min).

### -Preparation of Aqueous Phase-

A reaction container equipped with a stirring rod and a thermometer was charged with water (683 parts), a sodium salt of methacrylic acid ethylene oxide adduct sulfate ester (ELEMINOL RS-30, product of Sanyo Chemical Industries Ltd.) (11 parts), styrene (138 parts), methacrylic acid (138 parts) and ammonium persulphate (1 part). The resultant mixture was stirred at 400 rpm for 15 min to thereby obtain a white emulsion. The reaction system was heated to a temperature of 75° C., followed by reaction for 5 hours. In addition, 1% by mass aqueous solution of ammonium persulfate (30 parts) was added to the container. The resultant mixture was aged at 75° C. for 5 hours, to thereby obtain [particle dispersion liquid 1], which was an aqueous dispersion liquid of vinyl-based resin (copolymer of styrene, methacrylic acid, and a sodium salt of methacrylic acid ethylene oxide adduct sulfate ester). [Particle dispersion liquid 1] was found to have a volume average particle diameter of 0.14 μm when measured using LA-920. A part of [particle dispersion liquid 1] was dried to thereby separate resin.

Water (990 parts), [particle dispersion liquid 1] (83 parts), a 48.5% by mass aqueous solution of sodium dodecyldiphenyl ether disulfonate (ELEMINOL MON-7, product of Sanyo Chemical Industries Ltd.) (37 parts) and ethyl acetate (90 parts) were mixed together and stirred to obtain an opaque white liquid, which was used as [aqueous phase 1].

### -Emulsification or Dispersion-

[Oil phase 1] (664 parts), [prepolymer 1] (109.4 parts), [crystalline polyester resin dispersion liquid 1] (73.9 parts), and [ketimine compound 1] (4.6 parts) were placed in a container, followed by mixing for 1 min at 5,000 rpm using TK HOMOMIXER (product of PRIMIX Corporation). Thereafter, [aqueous phase 1] (1,200 parts) was added to the container, and the resultant mixture was mixed using TK HOMOMIXER at 13,000 rpm for 20 min, to thereby obtain [emulsified slurry 1].

### -Removal of Solvent-

A container equipped with a stirrer and a thermometer was charged with [emulsified slurry 1], followed by desolvation at 30° C. for 8 hours and aging at 45° C. for 5 hours, to thereby obtain [dispersion slurry 1].

### -Washing and Drying-

[Dispersion slurry 1] (100 parts) was filtrated under a reduced pressure and then subjected to a series of treatments (1) to (4) described below:

(1): ion-exchanged water (100 parts) was added to a filtration cake, followed by mixing using TK HOMOMIXER (at 12,000 rpm for 10 min) and then filtration;

(2): 10% by mass aqueous solution of sodium hydroxide (100 parts) was added to the filtration cake obtained in (1), followed by mixing using TK HOMOMIXER (at 12,000 rpm for 30 min) and then filtration under a reduced pressure;

(3): 10% by mass hydrochloric acid (100 parts) was added to the filtration cake obtained in (2), followed by mixing using TK HOMOMIXER (at 12,000 rpm for 10 min) and then filtration; and

(4): ion-exchanged water (300 parts) was added to the filtration cake obtained in (3), followed by mixing using TK HOMOMIXER (at 12,000 rpm for 10 min) and then filtration.

A series of the treatments (1) to (4) was performed twice to thereby obtain a filtration cake. Thus obtained filtration cake was dried using an air-circulating drier at 45° C. for 48 hours, and then was caused to pass through a sieve with a mesh size of 75 μm, to thereby obtain [toner base particles A].

### <External Additive Treatment>

[Toner base particles A] (100 parts) was mixed with [coalesced particles a] shown in Table 2 (2.0 parts), silica having an average particle diameter of 20 nm (“H1303VP”, product of Clariant (Japan) K.K.) (2.0 parts), and titanium oxide having an average particle diameter of 20 nm (“JMT-150IB”, product of Tayca Corporation) (0.6 parts) using HENSCHEL MIXER, followed by sieving with a 500 mesh sieve to thereby obtain [Toner 1].

### Examples 2 to 10

[Toner 2] to [toner 10] were obtained in the same manner as in Example 1, except that [coalesced particles a] was changed to each of [coalesced particles b] to [coalesced particles j] shown in Table 2.

### Example 11

### <Production of Toner Base Particles B (Dissolution-Suspension Method)>

### -Preparation of Oil Phase-

A container equipped with a stirring rod and a thermometer was charged with [unmodified polyester resin 1] (378 parts), carnauba wax (110 parts), salicylic acid metal complex (E-84: product of Orient Chemical Industries, Ltd.) (22 parts) and ethyl acetate (947 parts). The resultant mixture was heated to 80° C. under stirring, maintained at 80° C. for 5 hours and then cooled to 30° C. for 1 hour. Subsequently, [masterbatch 1] (500 parts) and ethyl acetate (500 parts) were charged into the container, followed by mixing for 1 hour, to thereby obtain [raw material solution 2]. Thus obtained [raw material solution 2] (1,324 parts) was placed in a container. C.I. Pigment Red and carnauba wax were dispersed using a beads mill (ULTRA VISCOMILL, product of AIMEX CO., Ltd.) under the following conditions: a liquid feed rate of 1 kg/hr, disc circumferential velocity of 6 m/s, 0.5 mm-zirconia beads packed in 80% by volume, and 3 passes, to thereby obtain [pigment/wax dispersion liquid 2]. Next, a 65% by mass ethyl acetate solution of the [unmodified polyester resin 1] (1,324 parts) was added to [pigment/wax dispersion liquid 2], and passed once through the beads mill under the above conditions, to thereby obtain a dispersion liquid. To the resultant dispersion liquid (200 parts), was added montmorillonite (CLAYTONE APA, produced by Southern Clay Products, Inc.) (1.0 part) which is a layered inorganic mineral of which at least some ions have been modified with a benzyl group-containing quaternary ammonium salt. Then, the resultant mixture was agitated for 30 min using T.K. HOMODISPER (product of PRIMIX Corporation) to thereby obtain [oil phase 2] as a toner material dispersion liquid.

### -Preparation of Aqueous Phase-

Water (660 parts), [particle dispersion liquid 1] (25 parts), a 48.5% by mass aqueous solution of sodium dodecyldiphenyl ether disulfonate (ELEMINOL MON-7, product of Sanyo Chemical Industries Ltd.) (25 parts) and ethyl acetate (60 parts) were mixed together and stirred to thereby obtain an opaque white liquid, which was used as [aqueous phase 2]. Aggregates with several hundreds micrometers were observed in [aqueous phase 2] under an optical microscope. [Aqueous phase 2] was stirred using TK HOMOMIXER (Product of PRIMIX Corporation) at 8,000 rpm. As a result, the aggregates were separated to small aggregates with several micrometers, which was confirmed under the optical microscope.

### -Emulsification or Dispersion-

[Aqueous phase 2] (150 parts) was placed into a container, and stirred using TK HOMOMIXER (Product of PRIMIX Corporation) at 12,000 rpm. [Oil phase 2] (100 parts) was added thereto and mixed together for 10 min to thereby prepare [emulsified slurry 2].

### -Removal of Solvent-

A flask equipped with a drainpipe, a stirring rod and a thermometer was charged with [emulsified slurry 2] (100 parts), followed by desolvation at 30° C. for 12 hours under a reduced pressure with stirring (circumferential speed: 20 m/min), to thereby obtain a dispersion slurry. The resultant dispersion slurry was heated to 60° C. to thereby fix resin particles on the toner surfaces, which was used as [dispersion slurry 2].

### -Washing and Drying-

The total amount of [dispersion slurry 2] was filtrated under a reduced pressure. Thereafter, ion-exchanged water (300 parts) was added to the resultant filtration cake, followed by mixing and redispersing using TK HOMOMIXER (at 12,000 rpm for 10 min) and then filtration. Ion-exchanged water (300 parts) was added to the resultant filtration cake, followed by mixing using TK HOMOMIXER (at 12,000 rpm for 10 min) and then filtration (this treatment was repeated for three times). The resultant filtration cake was dried using an air-circulating drier at 45° C. for 48 hours, and then was caused to pass through a sieve with a mesh size of 75 μm, to thereby obtain [toner base particles B].

### <External Additive Treatment>

[Toner base particles B] (100 parts) was mixed with [coalesced particles a] shown in Tables 3-1 and 3-2 (2.0 parts), silica having an average particle diameter of 20 nm (“H1303VP”, product of Clariant (Japan) K.K.) (2.0 parts), and titanium oxide having an average particle diameter of 20 nm (“JMT-150IB”, product of Tayca Corporation) (0.6 parts) using HENSCHEL MIXER, followed by sieving with a 500 mesh sieve thereby obtain [toner 11].

### Examples 12 to 20

[Toner 12] to [toner 20] were obtained in the same manner as in Example 11, except that [coalesced particles a] was changed to [coalesced particles b] to [coalesced particles j] shown in Tables 3-1 and 3-2, respectively.

### Example 21

### <Production of Toner Base Particles C (Emulsification-Aggregation Method)>

[Monomer mixture liquid 1] was produced by uniformly mixing the following monomers.

| | |
|---|---|
| Styrene monomer | 71 parts |
| n-butyl acrylate | 25 parts |
| Acrylic acid | 4 parts |

An aqueous solution mixture having the following composition was placed in a reactor and heated to 70° C. under stirring. Under stirring with keeping a temperature of the aqueous solution mixture at 70° C., [monomer mixture liquid 1] and a 1% aqueous solution of potassium persulfate (5 parts) were simultaneously added dropwise for 4 hours, followed by polymerization at 70° C. for 2 hours to thereby obtain [resin emulsion 1] having a solid content of 50%.

| | | |
|---|---|---|
| Water | 100 | parts |
| Nonionic emulsifier (EMALGEN 950, product of Kao | 1 | part |
| Corporation) | | |
| Anionic emulsifier (NEOGEN R, product of Dai-ichi | 1.5 | parts |
| Kogyo Seiyaku Co., Ltd.) | | |

The following mixture was agitated for 2 hours using a dispersing device with keeping a temperature at 25° C. to thereby obtain [pigment dispersion liquid 1].

| | | |
|---|---|---|
| Pigment (copper phthalocyanine, product by Toyo Ink | 20 | parts |
| Co., Ltd.) | | |
| Charge controlling agent (E-84, produced by Orient | 1 | part |
| Chemical Industries) | | |
| Anionic emulsifier (NEOGEN R, product of Dai-ichi | 0.5 | parts |
| Kogyo Seiyaku Co., Ltd.) | | |
| Water | 310 | parts |

Subsequently, [resin emulsion 1] (188 parts) was added to [pigment dispersion liquid 1]. The resultant mixture was agitated for approximately 2 hours, heated to 60° C. and then adjusted to pH 7.0 using ammonia. Further, the resultant dispersion liquid was heated to 90° C., maintained at 90° C. for 2 hours to thereby obtain [dispersion slurry 3]. The [dispersion slurry 3] (100 parts) was filtrated under a reduced pressure and then subjected to a series of treatments (1) to (3) described below:

(1): ion-exchanged water (100 parts) was added to the filtration cake, followed by mixing using TK HOMOMIXER (at 12,000 rpm for 10 min) and then filtration;

(2): 10% by mass hydrochloric acid was added to the filtration cake obtained in (1) to thereby adjust to pH 2.8, followed by mixing using TK HOMOMIXER (at 12,000 rpm for 10 min) and then filtration; and

(3): ion-exchanged water (300 parts) was added to the filtration cake obtained in (2), followed by mixing using TK HOMOMIXER (at 12,000 rpm for 10 min) and then filtration (this treatment (3) was performed twice).

Thus obtained filtration cake was dried using an air-circulating drier at 45° C. for 48 hours, and then was caused to pass through a sieve with a mesh size of 75 μm, to thereby obtain [toner base particles C].

### <External Additive Treatment>

[Toner base particles C] (100 parts) was mixed with [coalesced particles a] shown in Tables 3-1 and 3-2 (2.0 parts), silica having an average particle diameter of 20 nm (“H1303VP”, product of Clariant (Japan) K.K.) (2.0 parts), and titanium oxide having an average particle diameter of 20 nm (“JMT-150IB”, product of Tayca Corporation) (0.6 parts) using HENSCHEL MIXER, followed by sieving with a 500 mesh sieve to thereby obtain [Toner 21].

### Examples 22 to 30

[Toner 22] to [toner 30] were obtained in the same manner as in Example 21, except that [coalesced particles a] was changed to [coalesced particles b] to [coalesced particles j] shown in Tables 3-1 and 3-2, respectively.

### Example 31

### <Production of Toner Base Particles (Pulverization Method)>

### -Synthesis of Polyester Resins 1 and 2-

A reaction container equipped with a thermometer, a stirrer, a condenser and a nitrogen-introducing pipe was charged with bisphenol A PO adduct (adduct of propylene oxide to bisphenol A, hydroxyl value: 320, trade name “bisphenol A propylene oxide adduct”, product of Sigma-Aldrich Corporation) (443 parts), diethylene glycol (135 parts), terephthalic acid (211 parts), fumaric acid (211 parts) and dibutyltin oxide (2.5 parts). The resultant mixture was reacted with each other at 150° C. to 230° C. to thereby yield two types of polyester resins. Among them, one polyester resin having a lower molecular weight is referred to as [polyester resin 1] (Mw: 16,000) and other polyester resin having a higher molecular weight is referred to as [polyester resin 2] (Mw: 32,000).

### -Preparation of Masterbatch 2-

[Masterbatch 2] (dispersion in which a colorant has been uniformly dispersed within a portion of [polyester resin 1]) used for the toner formulation was prepared as follows. The following materials shown in [Composition of Masterbatch 2] were mixed together using HENSCHEL MIXER (HENSCHEL 20B, product of NIPPON COKE & ENGINEERING COMPANY, LIMITED) at 1,500 rpm for 3 min. The resultant mixture was kneaded at 120° C. for 45 min using a two-roller mill, and then rolled, cooled and pulverized using a pulverizer, to thereby obtain [masterbatch 2].

### [Composition of Masterbatch 2]

| | |
|---|---|
| Water | 25 parts |
| Copper phthalocyanine (product by Toyo Ink Co., Ltd.) | 50 parts |
| Polyester resin 1 (Mw: 16,000) | 50 parts |

Toner base particles D was prepared as follows. The following materials shown in [Composition of Toner Base Particles D] were mixed together using HENSCHEL MIXER (HENSCHEL 20B, product of NIPPON COKE & ENGINEERING COMPANY, LIMITED) at 1,500 rpm for 3 min, and kneaded using a single screw kneader (small type BUSS KO-KNEADER, product of Buss company) under the following conditions: preset temperature: 90° C. (at inlet) and 60° C. (at outlet), feed rate (10 kg/hr), to thereby obtain [base toner d]. The resultant [base toner d] was kneaded, and then rolled, cooled and pulverized using a pulverizer (product of Hosokawa Micron Corp.) Thereafter, the resultant pulverized product was further pulverized using I-type mill (model IDS-2, product of Nippon Neumatic Co., Ltd.) with a planer collision plate under the following conditions: air pressure: 6.0 atm/cm², feed rate: 0.5 kg/hr. The resultant was classified using a classifying device (132MP, product of Hosokawa Alpine AG) to thereby obtain [toner base particles D].

### [Composition of Toner Base Particles D]

| | |
|---|---|
| Polyester resin 1 (Mw: 16,000) | 51 parts |
| Polyester resin 2 (Mw: 32,000) | 45 parts |
| Paraffin wax (HNP-11, product of Nippon Seiro Co., Ltd.) | 5 parts |
| Masterbatch 2 | 8 parts |

### <External Additive Treatment>

[Toner base particles D] (100 parts) was mixed with [coalesced particles a] shown in Tables 3-1 and 3-2 (2.0 parts), silica having an average particle diameter of 20 nm (“H1303VP”, product of Clariant (Japan) K.K.) (2.0 parts), and titanium oxide having an average particle diameter of 20 nm (“JMT-150IB”, product of Tayca Corporation) (0.6 parts) using HENSCHEL MIXER, followed by sieving with a 500 mesh sieve to thereby obtain [Toner 31].

### Examples 32 to 40

[Toner 32] to [toner 40] were obtained in the same manner as in Example 31, except that [coalesced particles a] was changed to [coalesced particles b] to [coalesced particles j] shown in Tables 3-1 and 3-2, respectively.

### Comparative Example 1

[Toner 41] was obtained in the same manner as in Example 1, except that [coalesced particles a] was changed to [coalesced particles k] shown in Tables 3-1 and 3-2.

### Comparative Example 2

[Toner 42] was obtained in the same manner as in Example 1, except that [coalesced particles a] was changed to [coalesced particles l] shown in Tables 3-1 and 3-2.

### Comparative Example 3

[Toner 43] was obtained in the same manner as in Example 11, except that [coalesced particles a] was changed to [coalesced particles m] shown in Tables 3-1 and 3-2.

### Comparative Example 4

[Toner 44] was obtained in the same manner as in Example 11, except that [coalesced particles a] was changed to [coalesced particles n] shown in Tables 3-1 and 3-2.

### Comparative Example 5

[Toner 45] was obtained in the same manner as in Example 21, except that [coalesced particles a] was changed to [coalesced particles o] shown in Tables 3-1 and 3-2.

### Comparative Example 6

[Toner 46] was obtained in the same manner as in Example 21, except that [coalesced particles a] was changed to [coalesced particles p] shown in Tables 3-1 and 3-2.

### Comparative Example 7

[Toner 47] was obtained in the same manner as in Example 31, except that [coalesced particles a] was changed to [coalesced particles q] shown in Tables 3-1 and 3-2.

### Comparative Example 8

[Toner 48] was obtained in the same manner as in Example 31, except that [coalesced particles a] was changed to [coalesced particles r] shown in Tables 3-1 and 3-2.

### (Evaluation)

The toners produced in the above Examples and Comparative Examples were evaluated in their transferability, low temperature fixability, heat resistance storageability, and filming property. Results are shown in Tables 3-1 and 3-2. Notably, based on the evaluation results, the toners were overall judged. In a overall judgment, “A” and “B” were considered as usable, and “C” was considered as unusable.

### [Judgment Criteria]

A: There are three or more “A,” and no “B” and “C” in each evaluation.
B: There are two or less “A,” and no “B” and “C” in each evaluation.
C: There is at least one “C” in each evaluation.

### <Transferability>

A chart with an image area ratio of 20% was transferred from a photoconductor to paper using a digital full-color image forming apparatus (IMAGIO MP C 7501, product of Ricoh Company, Ltd.). Thereafter, at a time point just before a cleaning step, the toner remaining on the photoconductor was transferred onto a blank paper sheet using a piece of scotch tape (product of Sumitomo 3M Ltd.). Thus transferred paper sheet was measured using a MACBETH reflective densitometer model RD514 and evaluated according to the following criteria. Notably, “A”, “B”, and “C” were considered as “pass”, and “D” was considered as “failure.”

### [Evaluation Criteria]

A: Difference from the blank<0.005
B: 0.005≦Difference from the blank<0.010
C: 0.011≦Difference from the blank<0.020
D: 0.020≦Difference from the blank

### <Low Temperature Fixability>

A copying test was performed on recording paper sheets (Type 6200, product of Ricoh Company, Ltd.) using a modified image forming apparatus (MF-2200, product of Ricoh Company, Ltd.) in which, at a fixing part, TEFLON (registered trade mark) roller was used as a fixing roller. Specifically, the copying tests were performed with varying fixing temperature to thereby determine a cold offset temperature (minimum fixing temperature) and a hot offset temperature (maximum fixing temperature). The conditions for evaluating the minimum fixing temperature were as follows: linear velocity for feeding paper: 120 mm/sec to 150 mm/sec, surface pressure: 1.2 kgf/cm² and nip width: 3 mm. The conditions for evaluating the maximum fixing temperature were as follows: linear velocity for feeding paper: 50 mm/sec, surface pressure: 2.0 kgf/cm² and nip width: 4.5 mm. The low temperature fixability was evaluated according to the following evaluation criteria. Notably, “A” and “B” were considered as “pass”, and “C” was considered as “failure.”A conventional toner has a minimum fixing temperature of about 140° C.

### [Evaluation Criteria]

A: Minimum fixing temperature<120° C.
B: 120° C.≦Minimum fixing temperature<140° C.
C: 140° C.≦Minimum fixing temperature<150° C.

### <Heat Resistance Storageability>

The toners were stored at 40° C. and 70% RH for 2 weeks. Subsequently, the toners were sieved with a 200 mesh sieve for 1 min. Then, a rate of the toner remaining on the sieve (residual rate) was measured and evaluated according to the following evaluation criteria. The less the residual rate of the toner is, the better the heat resistance storageability is. Notably, “A” and “B” were considered as “pass”, and “C” was considered as “failure.”

### [Evaluation Criteria]

A: Residual rate<0.1%
B: 0.1%≦Residual rate<1.0%
C: 1.0%≦Residual rate

### <Filming Property>

A toner to be evaluated and an image forming apparatus (IMAGIO MP C 7501, product of Ricoh Company, Ltd.) were left to stand for one day in a room having a temperature of 25° C. and a relative humidity of 50%. All toner contained in a small and long-life photoconductor unit (PCU) of the image forming apparatus was removed, such that only a carrier was left in the developing device. To the developing device in which only the carrier was present, was added the toner (28 g) to thereby produce a developer having a toner concentration of 7% by mass (400 g). The developing device was installed in a main body of the image forming apparatus, and only the developing device was idled for 5 min at a linear velocity of a developing sleeve (sleeve forming a surface of a developing roller) of 300 mm/s. The developing sleeve and the photoconductor were both rotated by trailing at a target linear velocity. A charge potential and a developing bias were adjusted such that an amount of the toner on the photoconductor was 0.4±0.05 mg/cm². Under the above-mentioned developing conditions, a transfer current was adjusted such that a transfer rate was 96%±2%. Entire-surface solid images were continuously output for 10,000 sheets. The outputted images were subjected to sensory evaluation for image quality, and the number of white voids due to filming was counted. Notably, “A” and “B” were considered as “pass”, and “C” was considered as “failure.” The filming property was evaluated according to the following evaluation criteria.

### [Evaluation Criteria]

A: White voids area is very small (Number of white voids<5)
B: White voids area is usual (5≦Number of white voids<10)
C: White voids area is very large (10≦Number of white voids)

TABLE 3-1

| | Toner | | | | | | | |
|---|---|---|---|---|---|---|---|---|
| | | | External | Evaluation | | | | |
| | | Toner | additive | | | Low | | |
| | | base | (coalesced | Transfer- | Filming | Temperature | Storage- | Overall |
| | Type | particles | particles) | ability | property | Fixability | ability | Judgment |
| Ex. 1 | 1 | A | a | A | A | A | A | A |
| Ex. 2 | 2 | A | b | B | B | A | B | B |
| Ex. 3 | 3 | A | c | A | B | A | B | B |
| Ex. 4 | 4 | A | d | B | B | A | B | B |
| Ex. 5 | 5 | A | e | A | B | A | B | B |
| Ex. 6 | 6 | A | f | B | A | A | B | B |
| Ex. 7 | 7 | A | g | A | A | A | B | A |
| Ex. 8 | 8 | A | h | B | A | A | B | B |
| Ex. 9 | 9 | A | i | A | A | A | B | A |
| Ex. 10 | 10 | A | j | B | B | A | B | B |
| Ex. 11 | 11 | B | a | A | A | A | B | A |
| Ex. 12 | 12 | B | b | B | A | A | B | B |
| Ex. 13 | 13 | B | c | A | A | A | B | A |
| Ex. 14 | 14 | B | d | B | A | A | B | B |
| Ex. 15 | 15 | B | e | A | A | B | A | A |
| Ex. 16 | 16 | B | f | B | A | B | A | B |
| Ex. 17 | 17 | B | g | A | A | B | A | A |
| Ex. 18 | 18 | B | h | B | A | B | A | B |
| Ex. 19 | 19 | B | i | A | A | B | A | A |
| Ex. 20 | 20 | B | j | B | B | A | B | B |
| Ex. 21 | 21 | C | a | A | A | A | B | A |
| Ex. 22 | 22 | C | b | B | B | A | B | B |
| Ex. 23 | 23 | C | c | A | B | A | B | B |
| Ex. 24 | 24 | C | d | B | B | A | B | B |
| Ex. 25 | 25 | C | e | A | B | B | B | B |
| Ex. 26 | 26 | C | f | B | A | B | B | B |
| Ex. 27 | 27 | C | g | A | A | B | B | B |
| Ex. 28 | 28 | C | h | B | A | B | B | B |
| Ex. 29 | 29 | C | i | A | A | B | B | B |
| Ex. 30 | 30 | C | j | B | B | B | B | B |
| Ex. 31 | 31 | D | a | A | A | B | A | A |
| Ex. 32 | 32 | D | b | B | B | B | A | B |
| Ex. 33 | 33 | D | c | A | B | B | A | B |
| Ex. 34 | 34 | D | d | B | B | B | A | B |
| Ex. 35 | 35 | D | e | A | B | B | A | B |
| Ex. 36 | 36 | D | f | B | A | B | A | B |
| Ex. 37 | 37 | D | g | B | A | B | A | B |
| Ex. 38 | 38 | D | h | B | A | B | A | B |
| Ex. 39 | 39 | D | i | B | A | B | A | B |
| Ex. 40 | 40 | D | j | B | B | B | A | B |

TABLE 3-2

| | Toner | | | | | | | |
|---|---|---|---|---|---|---|---|---|
| | | | External | Evaluation | | | | |
| | | Toner | additive | | | Low | | |
| | | base | (coalesced | Transfer- | Filming | Temperature | Storage- | Overall |
| | Type | particles | particles) | ability | property | Fixability | ability | Judgment |
| Comp. | 41 | A | k | D | B | B | B | C |
| Ex. 1 | | | | | | | | |
| Comp. | 42 | A | l | D | C | B | B | C |
| Ex. 2 | | | | | | | | |
| Comp. | 43 | B | m | D | C | B | B | C |
| Ex. 3 | | | | | | | | |
| Comp. | 44 | B | n | D | C | B | B | C |
| Ex. 4 | | | | | | | | |
| Comp. | 45 | C | o | D | B | B | B | C |
| Ex. 5 | | | | | | | | |
| Comp. | 46 | C | p | D | C | B | B | C |
| Ex. 6 | | | | | | | | |
| Comp. | 47 | D | q | D | B | B | B | C |
| Ex. 7 | | | | | | | | |
| Comp. | 48 | D | r | D | C | B | B | C |
| Ex. 8 | | | | | | | | |

It has been found that the toner of the present invention is satisfactory in all of low temperature fixability, heat resistance storageability, transferability, and filming property even after long-term use. Thus, the toner can be suitably used in an electrophotographic image forming apparatus such as a copier, an electrostatic printing apparatus, a printer, a facsimile and an electrostatic recording apparatus.

Aspects of the present invention are as follows, for example.

<1> A toner including:

toner base particles; and

an external additive,

the toner base particles each including a binder resin and a colorant,

wherein the external additive includes coalesced particles,

wherein the coalesced particles are each a non-spherical secondary particle in which primary particles are coalesced together, and

wherein an index of a particle size distribution of the coalesced particles is expressed by the following Formula (1):

$$\frac{{Db}_{50}}{{Db}_{10}} ≦ 1.20 \qquad Formula ( 1 )$$

where, in a distribution diagram in which particle diameters in nm of the coalesced particles are on a horizontal axis and cumulative percentages in % by number of the coalesced particles are on a vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

<2> The toner according to <1>,

wherein the coalesced particles have an average of degrees of coalescence of 1.5 to 4.0, each of the degrees of coalescence being given by: a particle diameter of the secondary particle/an average particle diameter of the primary particles.

<3> The toner according to <2>,

wherein an amount of the coalesced particles having the degree of coalescence of less than 1.3 is 10% by number or less.

<4> The toner according to any one of <1> to <3>,

wherein the coalesced particles have an average particle diameter of 80 nm to 200 nm.

<5> The toner according to any one of <1> to <4>,

wherein the toner is produced through aqueous granulation.

<6> The toner according to any one of <1> to <5>,

wherein the toner is produced by mixing the external additive with the toner base particles, where the toner base particles are obtained through a process including: dissolving or dispersing at least the binder resin and the colorant in an organic solvent, to thereby prepare a solution or dispersion; adding the solution or dispersion to an aqueous phase so that the solution or dispersion is emulsified or dispersed in the aqueous phase, to thereby prepare an emulsion or dispersion liquid; and removing the organic solvent from the emulsion or dispersion liquid.

<7> The toner according to any one of <1> to <6>,

wherein the binder resin includes a crystalline polyester resin or a non-crystalline polyester resin.

<8> A two-component developer including:

the toner according to any one of <1> to <7>; and

a carrier.

<9> An image forming apparatus including:

a latent electrostatic image bearing member;

a latent electrostatic image forming unit configured to form a latent electrostatic image on the latent electrostatic image bearing member;

a developing unit configured to develop the latent electrostatic image with the toner according to any one of <1> to <7>, to thereby form a visible image;

a transfer unit configured to transfer the visible image onto a recording medium; and

a fixing unit configured to fix the visible image transferred on the recording medium.

<10> The image forming apparatus according to <9>,

wherein a linear velocity of the latent electrostatic image bearing member is 300 mm/sec or more.

This application claims priority to Japanese application No. 2012-057366, filed on Mar. 14, 2012 and incorporated herein by reference.

What is claimed is:

1. A toner comprising:
toner base particles; and
an external additive,
the toner base particles each comprising a binder resin and a colorant,
wherein the external additive comprises coalesced particles,
wherein the coalesced particles are each a non-spherical secondary particle in which primary particles are coalesced together, and
wherein an index of a particle size distribution of the coalesced particles is expressed by the following Formula (1):
$$\frac{{Db}_{50}}{{Db}_{10}} ≦ 1.20 \qquad Formula ( 1 )$$
where, in a distribution diagram in which particle diameters in nm of the coalesced particles are on a horizontal axis and cumulative percentages in % by number of the coalesced particles are on a vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

2. The toner according to claim 1,
wherein the coalesced particles have an average of degrees of coalescence of 1.5 to 4.0, each of the degrees of coalescence being given by: a particle diameter of the secondary particle/an average particle diameter of the primary particles.

3. The toner according to claim 2,
wherein an amount of the coalesced particles having the degree of coalescence of less than 1.3 is 10% by number or less.

4. The toner according to claim 1,
wherein the coalesced particles have an average particle diameter of 80 nm to 200 nm.

5. The toner according to claim 1,
wherein the toner is produced through aqueous granulation.

6. The toner according to claim 1,
wherein the toner is produced by mixing the external additive with the toner base particles, where the toner base particles are obtained through a process including: dissolving or dispersing at least the binder resin and the colorant in an organic solvent, to thereby prepare a solution or dispersion; adding the solution or dispersion to an aqueous phase so that the solution or dispersion is emulsified or dispersed in the aqueous phase, to thereby prepare an emulsion or dispersion liquid; and removing the organic solvent from the emulsion or dispersion liquid.

7. The toner according to claim 1,
wherein the binder resin comprises a crystalline polyester resin or a non-crystalline polyester resin.

8. A two-component developer comprising:
a toner; and
a carrier,
wherein the toner comprises:
toner base particles; and
an external additive,
the toner base particles each comprising a binder resin and a colorant,
wherein the external additive comprises coalesced particles,
wherein the coalesced particles are each a non-spherical secondary particle in which primary particles are coalesced together, and
wherein an index of a particle size distribution of the coalesced particles is expressed by the following Formula (1):
$$\frac{{Db}_{50}}{{Db}_{10}} ≦ 1.20 \qquad Formula ( 1 )$$
where, in a distribution diagram in which particle diameters in nm of the coalesced particles are on a horizontal axis and cumulative percentages in % by number of the coalesced particles are on a vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

9. An image forming apparatus comprising:
a latent electrostatic image bearing member;
a latent electrostatic image forming unit configured to form a latent electrostatic image on the latent electrostatic image bearing member;
a developing unit configured to develop the latent electrostatic image with a toner, to thereby form a visible image;
a transfer unit configured to transfer the visible image onto a recording medium; and
a fixing unit configured to fix the visible image transferred on the recording medium,
wherein the toner comprises:
toner base particles; and
an external additive,
the toner base particles each comprising a binder resin and a colorant,
wherein the external additive comprises coalesced particles,
wherein the coalesced particles are each a non-spherical secondary particle in which primary particles are coalesced together, and
wherein an index of a particle size distribution of the coalesced particles is expressed by the following Formula (1):
$$\frac{{Db}_{50}}{{Db}_{10}} ≦ 1.20 \qquad Formula ( 1 )$$
where, in a distribution diagram in which particle diameters in nm of the coalesced particles are on a horizontal axis and cumulative percentages in % by number of the coalesced particles are on a vertical axis and in which the coalesced particles are accumulated from the coalesced particles having smaller particle diameters to the coalesced particles having larger particle diameters, Db₅₀ denotes a particle diameter of the coalesced particle at which the cumulative percentage is 50% by number, and Db₁₀ denotes a particle diameter of the coalesced particle at which the cumulative percentage is 10% by number.

10. The image forming apparatus according to claim 9,
wherein a linear velocity of the latent electrostatic image bearing member is 300 mm/sec or more.
